(19) United States
(12) Patent Application Publication
(10) Pub. No.: US 2005/0203927 A1
(43) Pub. Date: Sep. 15, 2005

(54) Fast metadata generation and delivery

(75) Inventors: Sanghoon Sull, Seoul (KR); Jung Rim Kim, Seoul (KR); Hyeokman Kim, Seoul (KR); Ja-Cheon Yoon, Seoul (KR); Seong Soo Chun, Songnam City (KR)

Correspondence Address: D.A. STAUFFER PATENT SERVICES LLC, 1006 MONTFORD ROAD, CLEVLAND HTS., OH, 44121-2016, US

(73) Assignee: Vivcom, Inc., Palo Alto, CA (US)

(21) Appl. No.: 11/071,895

(22) Filed: Mar. 3, 2005

Related U.S. Application Data
(63) Continuation-in-part of application No. 09/911,293, filed on Jul. 23, 2001.
(63) Continuation-in-part of application No. 10/365,576, filed on Feb. 12, 2003.
(63) Continuation-in-part of application No. 10/368,333, filed on Feb. 18, 2003, now Pat. No. 6,768,693.
(63) Continuation-in-part of application No. 10/368,304, filed on Feb. 18, 2003.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.
(60) Provisional application No. 60/359,566, filed on Feb. 25, 2002.
(60) Provisional application No. 60/434,173, filed on Dec. 17, 2002.
(60) Provisional application No. 60/359,567, filed on Feb. 25, 2002.
(60) Provisional application No. 60/549,624, filed on Mar. 3, 2004.
(60) Provisional application No. 60/550,534, filed on Mar. 5, 2004.
(60) Provisional application No. 60/610,074, filed on Sep. 15, 2004.

(51) Int. Cl. G06F 17/00

(52) U.S. Cl. 707/100

(57) ABSTRACT

Fast metadata indexing and delivery for broadcast audio-visual (AV) programs by using template, segment-mark and bookmark on the visual spatio-temporal pattern of an AV program during indexing. The broadcasting time carried on a broadcast transport stream is used as a locator allowing direct access to a specific temporal position of a recorded AV program.

### CROSS-REFERENCE TO RELATED APPLICATIONS

All of the below-referenced applications for which priority claims are being made, or for which this application is a continuation-in-part of, are incorporated in their entirety by reference herein.

This application claims priority of U.S. Provisional Application Ser. No. 60/549,624 filed Mar. 3, 2004.

This application claims priority of U.S. Provisional Application Ser. No. 60/549,605 filed Mar. 3, 2004.

This application claims priority of U.S. Provisional Application Ser. No. 60/550,534 filed Mar. 5, 2004.

This application claims priority of U.S. Provisional Application Ser. No. 60/610,074 filed Sep. 15, 2004.

This is a continuation-in-part of U.S. patent application Ser. No. 09/911,293 filed Jul. 23, 2001 (published as US2002/0069218A1 on Jun. 6, 2002), which claims priority of:

U.S. Provisional Application Ser. No. 60/221,394 filed Jul. 24, 2000;

U.S. Provisional Application Ser. No. 60/221,843 filed Jul. 28, 2000;

U.S. Provisional Application Ser. No. 60/222,373 filed Jul. 31, 2000;

U.S. Provisional Application Ser. No. 60/271,908 filed Feb. 27, 2001; and

U.S. Provisional Application Ser. No. 60/291,728 filed May 17, 2001.

This is a continuation-in-part of U.S. patent application Ser. No. 10/365,576 filed Feb. 12, 2003 (published as US2004/0128317 on Jul. 1, 2004), which claims priority of U.S. Provisional Application Ser. No. 60/359,566 filed Feb. 25, 2002 and of U.S. Provisional Application Ser. No. 60/434,173 filed Dec. 17, 2002.

This is a continuation-in-part of U.S. patent application Ser. No. 10/369,333 filed Feb. 19, 2003 (published as US2003/0177503 on Sep. 18, 2003). Ser. This is a continuation-in-part of U.S. patent application Ser. No. 10/368,304 filed Feb. 18, 2003 (published as US2004/0125124 on Jul. 1, 2004), which claims priority of U.S. Provisional Application Ser. No. 60/359,567 filed Feb. 25, 2002.

### TECHNICAL FIELD

This disclosure relates to the methods and systems for fast metadata indexing and delivery for audio-visual (AV) programs.

### BACKGROUND

Advances in technology continue to create a wide variety of contents and services in audio, visual, and/or audiovisual (hereinafter referred generally and collectively as “audio-visual” or audiovisual”) programs/contents including related data(s) (hereinafter referred as a “program” or “content”) delivered to users through various media including broadcast terrestrial, cable and satellite as well as Internet.

Digital vs. Analog Television

In December 1996 the Federal Communications Commission (FCC) approved the U.S. standard for a new era of digital television (DTV) to replace the analog television (TV) system currently used by consumers. The need for a DTV system arose due to the demands for a higher picture quality and enhanced services required by television viewers. DTV has been widely adopted in various countries, such as Korea, Japan and throughout Europe.

The DTV system has several advantages over conventional analog television system to fulfill the needs of TV viewers. The standard definition television (SDTV) or high definition television (HDTV) digital television system allows for much clearer picture viewing, compared to a conventional analog TV system. HDTV viewers may receive high-quality pictures at a resolution of 1920×1080 pixels displayed in a wide screen format with a 16 by 9 aspect (width to height) ratio (as found in movie theatres) compared to analog's traditional analog 4 by 3 aspect ratio. Although the conventional TV aspect ratio is 4 by 3, wide screen programs can still be viewed on conventional TV screens in letter box format leaving a blank screen area at the top and bottom of the screen, or more commonly, by cropping part of each scene, usually at both sides of the image to show only the center 4 by 3 area. Furthermore, the DTV system allows multiple TV programs and may also contain ancillary data, such as subtitles, optional, varied or different audio options (such as optional languages), broader formats (such as letterbox) and additional scenes. For example, audiences may have the benefits of better associated audio, such as current 5.1-channel compact disc (CD)-quality surround sound for viewers to enjoy a more complete “home” theater experience.

The U.S. FCC has allocated 6 MHz (megaHertz) bandwidth for each terrestrial digital broadcasting channel which is the same bandwidth as used for analog National Television System Committee (NTSC) channel. By using video compression, such as MPEG-2, one or more programs can be transmitted within the same bandwidth. A DTV broadcaster thus may choose between various standards (for example, HDTV or SDTV) for transmission of programs. For example, Advanced Television Systems Committee (ATSC) has 18 different formats at various resolutions, aspect ratios, frame rates examples and descriptions of which may be found at “ATSC Standard A/53C with Amendment No. 1: ATSC Digital Television Standard”, Rev. C, 21 May 2004 (see World Wide Web at atsc.org). Pictures in DTV system is scanned in either progressive or interlaced modes. In progressive mode, a frame picture is scanned in a raster-scan order, whereas, in interlaced mode, a frame picture consists of two temporally-alternating field pictures each of which is scanned in a raster-scan order. A more detailed explanation on interlaced and progressive modes may be found at “Digital Video: An Introduction to MPEG-2” (Digital Multimedia Standards Series) by Barry G., Atul Puri, Arun N. Netravali. Although SDTV will not match HDTV in quality, it will offer a higher quality picture than current or recent analog TV.

Digital broadcasting also offers entirely new options and forms of programming. Broadcasters will be able to provide additional video, image and/or audio (along with other possible data transmission) to enhance the viewing experience of TV viewers. For example, one or more electronic program guides (EPGs) which may be transmitted with a video (usually a combined video plus audio with possible additional data) signal can guide users to channels of interest. The most common digital broadcasts and replays (for example, by video compact disc (VCD) or digital video disc (DVD)) involve compression of the video image for storage and/or broadcast with decompression for program presentation. Among the most common compression standards (which may also be used for associated data, such as audio) are JPEG and various MPEG standards.

1. JPEG Introduction

JPEG (Joint Photographic Experts Group) is a standard for still image compression. The JPEG committee has developed standards for the lossy, lossless, and nearly lossless compression of still images, and the compression of continuous-tone, still-frame, monochrome, and color images. The JPEG standard provides three main compression techniques from which applications can select elements satisfying their requirements. The three main compression techniques are (i) Baseline system, (ii) Extended system and (iii) Lossless mode technique. The Baseline system is a simple and efficient Discrete Cosine Transform (DCT)-based algorithm with Huffman coding restricted to 8 bits/pixel inputs in sequential mode. The Extended system enhances the baseline system to satisfy broader application with 12 bits/pixel inputs in hierarchical and progressive mode and the Lossless mode is based on predictive coding, DPCM (Differential Pulse Coded Modulation), independent of DCT with either Huffman or arithmetic coding.

2. JPEG Compression

An example of JPEG encoder block diagram may be found at Compressed Image File Formats: JPEG, PNG, GIF, XBM, BMP (ACM Press) by John Miano, more complete technical description may be found ISO/IEC International Standard 10918-1 (see World Wide Web at jpeg.org/jpeg/). An original picture, such as a video frame image is partitioned into 8×8 pixel blocks, each of which is independently transformed using DCT. DCT is a transform function from spatial domain to frequency domain. The DCT transform is used in various lossy compression techniques such as MPEG-1, MPEG-2, MPEG-4 and JPEG The DCT transform is used to analyze the frequency component in an image and discard frequencies which human eyes do not usually perceive. A more complete explanation of DCT may be found at “Discrete-Time Signal Processing” (Prentice Hall, 2^{nd} edition, February 1999) by Alan V. Oppenheim, Ronald W. Schafer, John R. Buck. All the transform coefficients are uniformly quantized with a user-defined quantization table (also called a q-table or normalization matrix). The quality and compression ratio of an encoded image can be varied by changing elements in the quantization table. Commonly, the DC coefficient in the top-left of a 2-D DCT array is proportional to the average brightness of the spatial block and is variable-length coded from the difference between the quantized DC coefficient of the current block and that of the previous block. The AC coefficients are rearranged to a 1-D vector through zig-zag scan and encoded with run-length encoding. Finally, the compressed image is entropy coded, such as by using Huffman coding. The Huffman coding is a variable-length coding based on the frequency of a character. The most frequent characters are coded with fewer bits and rare characters are coded with many bits. A more detailed explanation of Huffman coding may be found at “Introduction to Data Compression” (Morgan Kaufmann, Second Edition, February, 2000) by Khalid Sayood.

A JPEG decoder operates in reverse order. Thus, after the compressed data is entropy decoded and the 2-dimensional quantized DCT coefficients are obtained, each coefficient is dequantized using the quantization table. JPEG compression is commonly found in current digital still camera systems and many Karaoke “sing-along” systems.

Wavelet

Wavelets are transform functions that divide data into various frequency components. They are useful in many different fields, including multi-resolution analysis in computer vision, sub-band coding techniques in audio and video compression and wavelet series in applied mathematics. They are applied to both continuous and discrete signals. Wavelet compression is an alternative or adjunct to DCT type transformation compression and is considered or adopted for various MPEG standards, such as MPEG-4. A more complete description may be found at “Wavelet transforms: Introduction to Theory and Application” by Raghuveer M. Rao.

MPEG

The MPEG (Moving Pictures Experts Group) committee started with the goal of standardizing video and audio for compact discs (CDs). A meeting between the International Standards Organization (ISO) and the International Electrotechnical Commission (IEC) finalized a 1994 standard titled MPEG-2, which is now adopted as a video coding standard for digital television broadcasting. MPEG may be more completely described and discussed on the World Wide Web at mpeg.org along with example standards. MPEG-2 is further described at “Digital Video: An Introduction to MPEG-2 (Digital Multimedia Standards Series)” by Barry G. Haskell, Atul Puri, Arun N. Netravali and the MPEG-4 described at “The MPEG-4 Book” by Touradj Ebrahimi, Fernando Pereira.

MPEG Compression

The goal of MPEG standards compression is to take analog or digital video signals (and possibly related data such as audio signals or text) and convert them to packets of digital data that are more bandwidth efficient. By generating packets of digital data it is possible to generate signals that do not degrade, provide high quality pictures, and to achieve high signal to noise ratios.

MPEG standards are effectively derived from the Joint Pictures Expert Group (JPEG) standard for still images. The MPEG-2 video compression standard achieves high data compression ratios by producing information for a full frame video image only occasionally. These full-frame images, or “intra-coded” frames (pictures) are referred to as “I-frames”. Each I-frame contains a complete description of a single video frame (image or picture) independent of any other frame, and takes advantage of the nature of the human eye and removes redundant information in the high frequency which humans traditionally cannot see. These “I-frame” images act as “anchor frames” (sometimes referred to as “key frames” or “reference frames”) that serve as reference images within an MPEG-2 stream. Between the I-frames, delta-coding, motion compensation, and a variety of interpolative/predictive techniques are used to produce intervening frames. “Inter-coded” B-frames (bidirectionally-coded frames) and P-frames (predictive-coded frames) are examples of such “in-between” frames encoded between the I-frames, storing only information about differences between the intervening frames they represent with respect to the I-frames (reference frames). The MPEG system consists of two major layers namely, the System Layer (timing information to synchronize video and audio) and Compression Layer.

The MPEG standard stream is organized as a hierarchy of layers consisting of Video Sequence layer, Group-Of-Pictures (GOP) layer, Picture layer, Slice layer, Macroblock layer and Block layer.

The Video Sequence layer begins with a sequence header (and optionally other sequence headers), and usually includes one or more groups of pictures and ends with an end-of-sequence-code. The sequence header contains the basic parameters such as the size of the coded pictures, the size of the displayed video pictures if different,-bit rate, frame rate, aspect ratio of a video, the profile and level identification, interlace or progressive sequence identification, private user data, plus other global parameters related to a video.

The GOP layer consists of a header and a series of one or more pictures intended to allow random access, fast search and edition. The GOP header contains a time code used by certain recording devices. It also contains editing flags to indicate whether Bidirectional (B)-pictures following the first Intra (I)-picture of the GOP can be decoded following a random access called a closed GOP. In MPEG, a video picture is generally divided into a series of GOPs.

The Picture layer is the primary coding unit of a video sequence. A picture consists of three rectangular matrices representing luminance (Y) and two chrominance (Cb and Cr or U and V) values. The picture header contains information on the picture coding type of a picture (intra (I), predicted (P), Bidirectional (B) picture), the structure of a picture (frame, field picture), the type of the zigzag scan and other information related for the decoding of a picture. For progressive mode video, a picture is identical to a frame and can be used interchangeably, while for interlaced mode video, a picture refers to the top field or the bottom field of the frame.

A slice is composed of a string of consecutive macroblocks which is commonly built from a 2 by 2 matrix of blocks and it allows error resilience in case of data corruption. Due to the existence of a slice in an error resilient environment, a partial picture can be constructed instead of the whole picture being corrupted. If the bitstream contains an error, the decoder can skip to the start of the next slice. Having more slices in the bitstream allows better error hiding, but it can use space that could otherwise be used to improve picture quality. The slice is composed of macroblocks traditionally running from left to right and top to bottom where all macroblocks in the I-pictures are transmitted. In P and B-pictures, typically some macroblocks of a slice are transmitted and some are not, that is, they are skipped. However, the first and last macroblock of a slice should always be transmitted. Also the slices should not overlap.

A block consists of the data for the quantized DCT coefficients of an 8×8 block in the macroblock. The 8 by 8 blocks of pixels in the spatial domain are transformed to the frequency domain with the aid of DCT and the frequency coefficients are quantized. Quantization is the process of approximating each frequency coefficient as one of a limited number of allowed values. The encoder chooses a quantization matrix that determines how each frequency coefficient in the 8 by 8 block is quantized. Human perception of quantization error is lower for high spatial frequencies (such as color), so high frequencies are typically quantized more coarsely (with fewer allowed values).

The combination of the DCT and quantization results in many of the frequency coefficients being zero, especially those at high spatial frequencies. To take maximum advantage of this, the coefficients are organized in a zig-zag order to produce long runs of zeros. The coefficients are then converted to a series of run-amplitude pairs, each pair indicating a number of zero coefficients and the amplitude of a non-zero coefficient. These run-amplitudes are then coded with a variable-length code, which uses shorter codes for commonly occurring pairs and longer codes for less common pairs. This procedure is more completely described in “Digital Video: An Introduction to MPEG-2 (Chapman & Hall, December, 1996)” by Barry G. Haskell, Atul Puri, Arun N. Netravali. A more detailed description may also be found at “Generic Coding of Moving Pictures and Associated Audio Information—Part 2: Videos”, ISO/IEC 13818-2 (MPEG-2), 1994 (see World Wide Web at mpeg.org).

Inter-Picture Coding

Inter-picture coding is a coding technique used to construct a picture by using previously encoded pixels from the previous frames. This technique is based on the observation that adjacent pictures in a video are usually very similar. If a picture contains moving objects and if an estimate of their translation in one frame is available, then the temporal prediction can be adapted using pixels in the previous frame that are appropriately spatially displaced. The picture type in MPEG is classified into three types of picture according to the type of inter prediction used. A more detailed description of Inter-picture coding may be found at “Digital Video: An Introduction to MPEG-2” (Chapman & Hall, December, 1996) by Barry G. Haskell, Atul Puri, Arun N. Netravali.

Picture Types

The MPEG standards (MPEG-1, MPEG-2, MPEG-4) specifically define three types of pictures (frames) Intra (I), Predicted (P), and Bidirectional (B).

Intra (I) pictures are pictures that are traditionally coded separately only in the spatial domain by themselves. Since intra pictures do not reference any other pictures for encoding and the picture can be decoded regardless of the reception of other pictures, they are used as an access point into the compressed video. The intra pictures are usually compressed in the spatial domain and are thus large in size compared to other types of pictures.

Predicted (P) pictures are pictures that are coded with respect to the immediately previous I or P-frame. This technique is called forward prediction. In a P-picture, each macroblock can have one motion vector indicating the pixels used for reference in the previous I or P- frames. Since the a P-picture can be used as a reference picture for B-frames and future P-frames, it can propagate coding errors. Therefore the number of P-pictures in a GOP is often restricted to allow for a clearer video.

Bidirectional (B) pictures are pictures that are coded by using immediately previous I- and/or P-pictures as well as immediately next I- and/or P-pictures. This technique is called bidirectional prediction. In a B-picture, each macroblock can have one motion vector indicating the pixels used for reference in the previous I- or P-frames and another motion vector indicating the pixels used for reference in the next I- or P-frames. Since each macroblock in a B-picture can have up to two motion vectors, where the macroblock is obtained by averaging the two macroblocks referenced by the motion vectors, this results in the reduction of noise. In terms of compression efficiency, the B-pictures are the most efficient, P-pictures are somewhat worse, and the I-pictures are the least efficient. The B-pictures do not propagate errors because they are not traditionally used as a reference picture for inter-prediction.

Video Stream Composition

The number of I-frames in a MPEG stream (MPEG-1, MPEG-2 and MPEG-4) may be varied depending on the applications needed for random access and the location of scene cuts in the video sequence. In applications where random access is important, I-frames are used often, such as two times a second. The number of B-frames in between any pair of reference (I or P) frames may also be varied depending on factors such as the amount of memory in the encoder and the characteristics of the material being encoded. A typical display order of pictures may be found at “Digital Video: An Introduction to MPEG-2” (Digital Multimedia Standards Series) by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org). The sequence of pictures is re-ordered in the encoder such that the reference pictures needed to reconstruct B-frames are sent before the associated B-frames. A typical encoded order of pictures may be found at “Digital Video: An Introduction to MPEG-2” (Digital Multimedia Standards Series) by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

Motion Compensation

In order to achieve a higher compression ration, the temporal redundancy of a video is eliminated by a technique called motion compensation. Motion compensation is utilized in P- and B-pictures at macro block level where each macroblock has a spatial vector between the reference macroblock and the macroblock being coded and the error between the reference and the coded macroblock. The motion compensation for macroblocks in P-picture may only use the macroblocks in the previous reference picture (I-picture or P-picture), while macroblocks in a B-picture may use a combination of both the previous and future pictures as a reference pictures (I-picture or P-picture). A more extensive description of aspects of motion compensation may be found at “Digital Video: An Introduction to MPEG-2 (Digital Multimedia Standards Series)” by Barry G Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

MPEG-2 System Layer

A main function of MPEG-2 systems is to provide a means of combining several types of multimedia information into one stream. The MPEG-1 and MPEG-2 standards use packet multiplexing as a method for multiplexing. With packet multiplexing, Data packets from several elementary streams (ESs) (such as audio, video, textual data, and possibly other data) are interleaved into a single MPEG-2 stream as more completely described in “Generic Coding of Moving Pictures and Associated Audio Information—Part 2: Systems,” ISO/IEC 13818-1 (MPEG-2), 1994. ESs can be sent either at constant-bit rates or at variable-bit rates simply by varying the lengths or frequency of the packets. The ESs consist of compressed data from a single source plus ancillary data needed for synchronization, identification, and characterization of the source information. The ESs themselves are first packetized into either constant-length or variable-length packets to form a Packetized Elementary stream (PES).

MPEG-2 system coding is specified in two forms: the Program Stream (PS) and the Transport Stream (TS). The PS is used in relatively error-free environment such as DVD media, and the TS is used in environments where errors are likely, such as in digital broadcasting. The PS usually carries one program where a program is a combination of various ESs. The PS is made of packs of multiplexed data. Each pack consists of a pack header followed by a variable number of multiplexed PES packets from the various ESs plus other descriptive data. The TSs consists of TS packets, such as of 188 bytes, into which relatively long, variable length PES packets are further packetized. Each TS packet consists of a TS Header followed optionally by ancillary data (called an adaptation field), followed typically by one or more PES packets. The TS header usually consists of a sync (synchronization) byte, flags and indicators, packet identifier (PID), plus other information for error detection, timing and other functions. It is noted that the header and adaptation field of a TS packet shall not be scrambled.

In order to maintain proper synchronization between the ESs, for example, containing audio and video streams, synchronization is commonly achieved through the use of time stamp and clock reference. Time stamps for presentation and decoding are generally in units of 90 kHz, indicating the appropriate time according to the clock reference with a resolution of 27 MHz that a particular presentation unit (such as a video picture) should be decoded by the decoder and presented to the output device. A time stamp containing the presentation time of audio and video is commonly called the Presentation Time Stamp (PTS) that maybe present in a PES packet header, and indicates when the decoded picture is to be passed to the output device for display whereas a time stamp indicating the decoding time is called the Decoding Time Stamp (DTS). Program Clock Reference (PCR) in the Transport Stream (TS) and System Clock Reference (SCR) in the Program Stream (PS) indicate the sampled values of the system time clock. In general, the definitions of PCR and SCR may be considered to be equivalent, although there are distinctions. The PCR that maybe be present in the adaptation field of a TS packet provides the clock reference for one program, where a program consists of a set of ESs that has a common time base and is intended for synchronized decoding and presentation. There may be multiple programs in one TS, and each may have an independent time base and a separate set of PCRs. As an illustration of an exemplary operation of the decoder, the system time clock of the decoder is set to the value of the transmitted PCR (or SCR), and a frame is displayed when the system time clock of the decoder matches the value of the PTS of the frame. For consistency and clarity, the remainder of this disclosure will use the term PCR. However, equivalent statements and applications apply to the SCR or other equivalents or alternatives except where specifically noted otherwise. A more extensive explanation of MPEG-2 System Layer can be found in “Generic Coding of Moving Pictures and Associated Audio Information—Part 2: Systems,” ISO/IEC 13818-1 (MPEG-2), 1994.

Differences between MPEG-1 and MPEG-2

The MPEG-2 Video Standard supports both progressive scanned video and interlaced scanned video while the MPEG-1 Video standard only supports progressive scanned video. In progressive scanning, video is displayed as a stream of sequential raster-scanned frames. Each frame contains a complete screen-full of image data, with scanlines displayed in sequential order from top to bottom on the display. The “frame rate” specifies the number of frames per second in the video stream. In interlaced scanning, video is displayed as a stream of alternating, interlaced (or interleaved) top and bottom raster fields at twice the frame rate, with two fields making up each frame. The top fields (also called “upper fields” or “odd fields”) contain video image data for odd numbered scanlines (starting at the top of the display with scanline number 1), while the bottom fields contain video image data for even numbered scanlines. The top and bottom fields are transmitted and displayed in alternating fashion, with each displayed frame comprising a top field and a bottom field. Interlaced video is different from non-interlaced video, which paints each line on the screen in order. The interlaced video method was developed to save bandwidth when transmitting signals but it can result in a less detailed image than comparable non-interlaced (progressive) video.

The MPEG-2 Video Standard also supports both frame-based and field-based methodologies for DCT block coding and motion prediction while MPEG-1 Video Standard only supports frame-based methodologies for DCT. A block coded by field DCT method typically has a larger motion component than a block coded by the frame DCT method.

MPEG-4

The MPEG-4 is a Audiovisual (AV) encoder/decoder (codec) framework for creating and enabling interactivity with a wide set of tools for creating enhanced graphic content for objects organized in a hierarchical way for scene composition. The MPEG-4 video standard was started in 1993 with the object of video compression and to provide a new generation of coded representation of a scene. For example, MPEG-4 encodes a scene as a collection of visual objects where the objects (natural or synthetic) are individually coded and sent with the description of the scene for composition. Thus MPEG-4 relies on an object-based representation of a video data based on video object (VO) defined in MPEG-4 where each VO is characterized with properties such as shape, texture and motion. To describe the composition of these VOs to create audiovisual scenes, several VOs are then composed to form a scene with Binary Format for Scene (BIFS) enabling the modeling of any multimedia scenario as a scene graph where the nodes of the graph are the VOs. The BIFS describes a scene in the form a hierarchical structure where the nodes may be dynamically added or removed from the scene graph on demand to provide interactivity, mix/match of synthetic and natural audio or video, manipulation/composition of objects that involves scaling, rotation, drag, drop and so forth. Therefore the MPEG-4 stream is composed BIFS syntax, video/audio objects and other basic information such as synchronization configuration, decoder configurations and so on. Since BIFS contains information on the scheduling, coordinating in temporal and spatial domain, synchronization and processing interactivity, the client receiving the MPEG-4 stream needs to firstly decode the BIFS information that which composes the audio/video ES. Based on the decoded BIFS information the decoder accesses the associated audio-visual data as well as other possible supplementary data. To apply MPEG-4 object-based representation to a scene, objects included in the scene should first be detected and segmented which cannot be easily automated by using the current state-of-art image analysis technology.

H.264 (AVC)

H.264 also called Advanced Video Coding (AVC) or MPEG-4 part 10 is the newest international video coding standard. Video coding standards such as MPEG-2 enabled the transmission of HDTV signals over satellite, cable, and terrestrial emission and the storage of video signals on various digital storage devices (such as disc drives, CDs, and DVDs). However, the need for H.264 has arisen to improve the coding efficiency over prior video coding standards such MPEG-2.

Relative to prior video coding standards, H.264 has features that allow enhanced video coding efficiency. H.264 allows for variable block-size quarter-sample-accurate motion compensation with block sizes as small as 4×4 allowing more flexibility in the selection of motion compensation block size and shape over prior video coding standards.

H.264 has an advanced reference picture selection technique such that the encoder can select the pictures to be referenced for motion compensation compared to P- or B-pictures in MPEG-1 and MPEG-2 which may only reference a combination of a adjacent future and previous picture. Therefore a high degree of flexibility is provided in the ordering of pictures for referencing and display purposes compared to the strict dependency between the ordering of pictures for motion compensation in the prior video coding standard.

Another technique of H.264 absent from other video coding standards is that H.264 allows the motion-compensated prediction signal to be weighted and offset by amounts specified by the encoder to improve the coding efficiency dramatically.

All major prior coding standards (such as JPEG MPEG-1, MPEG-2) use a block size of 8×8 for transform coding while H.264 design uses a block size of 4×4 for transform coding. This allows the encoder to represent signals in a more adaptive way, enabling more accurate motion compensation and reducing artifacts. H.264 also uses two entropy coding methods, called CAVLC and CABAC, using context-based adaptivity to improve the performance of entropy coding relative to prior standards.

H.264 also provides robustness to data error/losses for a variety of network environments. For example, a parameter set design provides for robust header information which is sent separately for handling in a more flexible way to ensure that no severe impact in the decoding process is observed even if a few bits of information are lost during transmission. In order to provide data robustness H.264 partitions pictures into a group of slices where each slice may be decoded independent of other slices, similar to MPEG-1 and MPEG-2. However the slice structure in MPEG-2 is less flexible compared to H.264, reducing the coding efficiency due to the increasing quantity of header data and decreasing the effectiveness of prediction.

In order to enhance the robustness, H.264 allows regions of a picture to be encoded redundantly such that if the primary information regarding a picture is lost, the picture can be recovered by receiving the redundant information on the lost region. Also H.264 separates the syntax of each slice into multiple different partitions depending on the importance of the coded information for transmission.

ATSC/DVB

The ATSC is an international, non-profit organization developing voluntary standards for digital television (TV) including digital HDTV and SDTV. The ATSC digital TV standard, Revision B (ATSC Standard A/53B) defines a standard for digital video based on MPEG-2 encoding, and allows video frames as large as 1920×1080 pixels/pels (2,073,600 pixels) at 19.29 Mbps, for example. The Digital Video Broadcasting Project (DVB—an industry-led consortium of over 300 broadcasters, manufacturers, network operators, software developers, regulatory bodies and others in over 35 countries) provides a similar international standard for digital TV. Digitalization of cable, satellite and terrestrial television networks within Europe is based on the Digital Video Broadcasting (DVB) series of standards while USA and Korea utilize ATSC for digital TV broadcasting.

In order to view ATSC and DVB compliant digital streams, STBs which may be connected inside or associated with user's TV set began to penetrate TV markets. For purpose of this disclosure, the term STB is used to refer to any and all such display, memory, or interface devices intended to receive, store, process, repeat, edit, modify, display, reproduce or perform any portion of a program, including personal computer (PC) and mobile device. With this new consumer device, television viewers may record broadcast programs into the local or other associated data storage of their Digital Video Recorder (DVR) in a digital video compression format such as MPEG-2. A DVR is usually considered a STB having recording capability, for example in associated storage or in its local storage or hard disk. A DVR allows television viewers to watch programs in the way they want (within the limitations of the systems) and when they want (generally referred to as “on demand”). Due to the nature of digitally recorded video, viewers should have the capability of directly accessing a certain point of a recorded program (often referred to as “random access”) in addition to the traditional video cassette recorder (VCR) type controls such as fast forward and rewind.

In standard DVRs, the input unit takes video streams in a multitude of digital forms, such as ATSC, DVB, Digital Multimedia Broadcasting (DMB) and Digital Satellite System (DSS), most of them based on the MPEG-2 TS, from the Radio Frequency (RF) tuner, a general network (for example, Internet, wide area network (WAN), and/or local area network (LAN)) or auxiliary read-only disks such as CD and DVD.

The DVR memory system usually operates under the control of a processor which may also control the demultiplexor of the input unit. The processor is usually programmed to respond to commands received from a user control unit manipulated by the viewer. Using the user control unit, the viewer may select a channel to be viewed (and recorded in the buffer), such as by commanding the demultiplexor to supply one or more sequences of frames from the tuned and demodulated channel signals which are assembled, in compressed form, in the random access memory, which are then supplied via memory to a decompressor/decoder for display on the display device(s).

The DVB Service Information (SI) and ATSC Program Specific Information Protocol (PSIP) are the glue that holds the DTV signal together in DVB and ATSC, respectively. ATSC (or DVB) allow for PSIP (or SI) to accompany broadcast signals and is intended to assist the digital STB and viewers to navigate through an increasing number of digital services. The ATSC-PSIP and DVB-SI are more fully described in “ATSC Standard A/53C with Amendment No. 1: ATSC Digital Television Standard”, Rev. C, and in “ATSC Standard A/65B: Program and System Information Protocol for Terrestrial Broadcast and Cable”, Rev. B 18 March 2003 (see World Wide Web at atsc.org) and “ETSI EN 300 468 Digital Video Broadcasting (DVB); Specification for Service Information (SI) in DVB Systems” (see World Wide Web at etsi.org).

Within DVB-SI and ATSC-PSIP, the Event Information Table (EIT) is especially important as a means of providing program (“event”) information. For DVB and ATSC compliance it is mandatory to provide information on the currently running program and on the next program. The EIT can be used to give information such as the program title, start time, duration, a description and parental rating.

In the article “ATSC Standard A/65B: Program and System Information Protocol for Terrestrial Broadcast and Cable,” Rev. B, 18 Mar. 2003 (see World Wide Web at atsc.org), it is noted that PSIP is a voluntary standard of the ATSC and only limited parts of the standard are currently required by the Federal Communications Commission (FCC). PSIP is a collection of tables designed to operate within a TS for terrestrial broadcast of digital television. Its purpose is to describe the information at the system and event levels for all virtual channels carried in a particular TS. The packets of the base tables are usually labeled with a base packet identifier (PID, or base PID). The base tables include System Time Table (STT), Rating Region Table (RRT), Master Guide Table (MGT), Virtual Channel Table (VCT), Event Information Table (EIT) and Extent Text Table (ETT), while the collection of PSIP tables describe elements of typical digital TV service.

The STT is the simplest and smallest table in the PSIP table to indicate the reference for time of day to receivers. The System Time Table is a small data structure that fits in one TS packet and serves as a reference for time-of-day functions. Receivers or STBs can use this table to manage various operations and scheduled events, as well as display time-of-day. The reference for time-of-day functions is given in system time by the system_time field in the STT based on current Global Positioning Satellite (GPS) time, from 12:00 a.m. Jan. 6, 1980, in an accuracy of within 1 second. The DVB has a similar table called Time and Date Table (TDT). The TDT reference of time is based on the Universal Time Coordinated (UTC) and Modified Julian Date (MJD) as described in Annex C at “ETSI EN 300 468 Digital Video Broadcasting (DVB); Specification for Service Information (SI) in DVB systems” (see World Wide Web at etsi.org).

The Rating Region Table (RTT) has been designed to transmit the rating system in use for each country having such as system. In the United States, this is incorrectly but frequently referred to as the “V-chip” system; the proper title is “Television Parental Guidelines” (TVPG). Provisions have also been made for multi-country systems.

The Master Guide Table (MGT) provides indexing information for the other tables that comprise the PSIP Standard. It also defines table sizes necessary for memory allocation during decoding, defines version numbers to identify those tables that need to be updated, and generates the packet identifiers that label the tables. An exemplary Master Guide table (MGT) and its usage may be found at “ATSC Standard A/65B: Program and System Information Protocol for Terrestrial Broadcast and Cable, Rev. B 18 Mar. 2003” (see World Wide Web at atsc.org).

The Virtual Channel Table (VCT), also referred to as the Terrestrial VCT (TVCT), contains a list of all the channels that are or will be on-line, plus their attributes. Among the attributes given are the channel name, channel number, the carrier frequency and modulation mode to identify how the service is physically delivered. The VCT also contains a source identifier (ID) which is important for representing a particular logical channel. Each EIT contains a source ID to identify which minor channel will carry its programming for each 3 hour period. Thus the source ID may be considered as a Universal Resource Locator (URL) scheme that could be used to target a programming service. Much like Internet domain names in regular Internet URLs, such a source ID type URL does not need to concern itself with the physical location of the referenced service, providing a new level of flexibility into the definition of source ID. The VCT also contains information on the type of service indicating whether analog TV, digital TV or other data is being supplied. It also may contain descriptors indicating the PIDs to identify the packets of service and descriptors for extended channel name information.

The EIT table is a PSIP table that carries information regarding the program schedule information for each virtual channel. Each instance of an EIT traditionally covers a three hour span, to provide information such as event duration, event title, optional program content advisory data, optional caption service data, and audio service descriptor(s). There are currently up to 128 EITs—EIT-0 through EIT-127—each of which describes the events or television programs for a time interval of three hours. EIT-0 represents the “current” three hours of programming and has some special needs as it usually contains the closed caption, rating information and other essential and optional data about the current programming. Because the current maximum number of EITs is 128, up to 16 days of programming may be advertised in advance. At minimum, the first four EITs should always be present in every TS, and 24 are recommended. Each EIT-k may have multiple instances, one for each virtual channel in the VCT. The current EIT table contains information only on the current and future events that are being broadcast and that will be available for some limited amount of time into the future. However, a user might wish to know about a program previously broadcast in more detail.

The ETT table is an optional table which contains a detailed description in various languages for an event and/or channel. The detailed description in the ETT table is mapped to an event or channel by a unique identifier.

In the Article “ATSC Standard A/65B: Program and System Information Protocol for Terrestrial Broadcast and Cable,” Rev. B, 18 Mar. 2003 (see World Wide Web at atsc.org), it is noted that there may be multiple ETTs, one or more channel ETT sections describing the virtual channels in the VCT, and an ETT-k for each EIT-k, describing the events in the EIT-k. The ETTs are utilized in case it is desired to send additional information about the entire event since the number of characters for the title is restricted in the EIT. These are all listed in the MGT. An ETT-k contains a table instance for each event in the associated EIT-k. As the name implies, the purpose of the ETT is to carry text messages. For example, for channels in the VCT, the messages can describe channel information, cost, coming attractions, and other related data. Similarly, for an event such as a movie listed in the EIT, the typical message would be a short paragraph that describes the movie itself. ETTs are optional in the ATSC system.

The PSIP tables carry a mixture of short tables with short repeat cycles and larger tables with long cycle times. The transmission of one table must be complete before the next section can be sent. Thus, transmission of large tables must be complete within a short period in order to allow fast cycling tables to achieve specified time interval. This is more completely discussed at “ATSC Recommended Practice: Program and System Information Protocol Implementation Guidelines for Broadcasters” (see World Wide Web at atsc.org/standards/a_{—}69.pdf).

DVD

Digital Video (or Versatile) Disc (DVD) is a multi-purpose optical disc storage technology suited to both entertainment and computer uses. As an entertainment product DVD allows home theater experience with high quality video, usually better than alternatives, such as VCR, digital tape and CD.

DVD has revolutionized the way consumers use pre-recorded movie devices for entertainment. With video compression standards such as MPEG-2, content providers can usually store over 2 hours of high quality video on one DVD disc. In a double-sided, dual-layer disc, the DVD can hold about 8 hours of compressed video which corresponds to approximately 30 hours of VHS TV quality video. DVD also has enhanced functions, such as support for wide screen movies; up to eight (8) tracks of digital audio each with as many as eight (8) channels; on-screen menus and simple interactive features; up to nine (9) camera angles; instant rewind and fast forward functionality; multi-lingual identifying text of title name; album name, song name, and automatic seamless branching of video. The DVD also allows users to have a useful and interactive way to get to their desired scenes with the chapter selection feature by defining the start and duration of a segment along with additional information such as an image and text (providing limited, but effective random access viewing). As an optical format, DVD picture quality does not degrade over time or with repeated usage, as compared to video tapes (which are magnetic storage media). The current DVD recording format uses 4:2:2 component digital video, rather than NTSC analog composite video, thereby greatly enhancing the picture quality in comparison to current conventional NTSC.

TV-Anytime and MPEG-7

TV viewers are currently provided with information on programs such as title and start and end times that are currently being broadcast or will be broadcast, for example, through an EPG. At this time, the EPG contains information only on the current and future events that are being broadcast and that will be available for some limited amount of time into the future. However, a user might wish to know about a program previously broadcast in more detail. Such demands have arisen due to the capability of DVRs enabling recording of broadcast programs. A commercial DVR service based on proprietary EPG data format is available, as by the company TiVo (see World Wide Web at tivo.com).

The simple service information such as program title or synopsis that is currently delivered through the EPG scheme appears to be sufficient to guide users to select a channel and record a program. However, users might wish to fast access to specific segments within a recorded program in the DVR. In the case of current DVD movies, users can access to a specific part of a video through “chapter selection” interface. Access to specific segments of the recorded program requires segmentation information of a program that describes a title, category, start position and duration of each segment that could be generated through a process called “video indexing”. To access to a specific segment without the segmentation information of a program, viewers currently have to linearly search through the video from the beginning, as by using the fast forward button, which is a cumbersome and time-consuming process.

TV-Anytime

Local storage of AV content and data on consumer electronics devices accessible by individual users opens a variety of potential new applications and services. Users can now easily record contents of their interests by utilizing broadcast program schedules and later watch the programs, thereby taking advantage of more sophisticated and personalized contents and services via a device that is connected to various input sources such as terrestrial, cable, satellite, Internet and others. Thus, these kinds of consumer devices provide new business models to three main provider groups: content creators/owners, service providers/broadcasters and related third parties, among others. The global TV-Anytime Forum (see World Wide Web at tv-anytime.org) is an association of organizations which seeks to develop specifications to enable audio-visual and other services based on mass-market high volume digital local storage in consumer electronics platforms. The forum has been developing a series of open specifications since being formed on September 1999.

The TV-Anytime Forum identifies new potential business models, and introduced a scheme for content referencing with Content Referencing Identifiers (CRIDs) with which users can search, select, and rightfully use content on their personal storage systems. The CRID is a key part of the TV-Anytime system specifically because it enables certain new business models. However, one potential issue is, if there are no business relationships defined between the three main provider groups, as noted above, there might be incorrect and/or unauthorized mapping to content. This could result in a poor user experience. The key concept in content referencing is the separation of the reference to a content item (for example, the CRID) from the information needed to actually retrieve the content item (for example, the locator). The separation provided by the CRID enables a one-to-many mapping between content references and the locations of the contents. Thus, search and selection yield a CRID, which is resolved into either a number of CRIDs or a number of locators. In the TV-Anytime system, the main provider groups can originate and resolve CRIDs. Ideally, the introduction of CRIDs into the broadcasting system is advantageous because it provides flexibility and reusability of content metadata. In existing broadcasting systems, such as ATSC-PSIP and DVB-SI, each event (or program) in an EIT table is identified with a fixed 16-bit event identifier (EID). However, CRIDs require a rather sophisticated resolving mechanism. The resolving mechanism usually relies on a network which connects consumer devices to resolving servers maintained by the provider groups. Unfortunately, it may take a long time to appropriately establish the resolving servers and network.

TV-Anytime also defines the metadata format for metadata that may be exchanged between the provider groups and the consumer devices. In a TV-Anytime environment, the metadata includes information about user preferences and history as well as descriptive data about content such as title, synopsis, scheduled broadcasting time, and segmentation information. Especially, the descriptive data is an essential element in the TV-Anytime system because it could be considered as an electronic content guide. The TV-Anytime metadata allows the consumer to browse, navigate and select different types of content. Some metadata can provide in-depth descriptions, personalized recommendations and detail about a whole range of contents both local and remote. In TV-Anytime metadata, program information and scheduling information are separated in such a way that scheduling information refers its corresponding program information via the CRIDs. The separation of program information from scheduling information in TV-Anytime also provides a useful efficiency gain whenever programs are repeated or rebroadcast, since each instance can share a common set of program information.

The schema or data format of TV-Anytime metadata is usually described with XML Schema, and all instances of TV-Anytime metadata are also described in an eXtensible Markup Language (XML). Because XML is verbose, the instances of TV-Anytime metadata require a large amounts of data or high bandwidth. For example, the size of an instance of TV-Anytime metadata might be 5 to 20 times larger than that of an equivalent EIT (Event Information Table) table according to ATSC-PSIP or DVB-SI specification. In order to overcome the bandwidth problem, TV-Anytime provides a compression/encoding mechanism that converts an XML instance of TV-Anytime metadata into equivalent binary format. According to TV-Anytime, compression specification, the XML structure of TV-Anytime metadata is coded using BiM, an efficient binary encoding format for XML adopted by MPEG-7. The Time/Date and Locator fields also have their own specific codecs. Furthermore, strings are concatenated within each delivery unit to ensure efficient Zlib compression is achieved in the delivery layer. However, despite the use of the three compression techniques in TV-Anytime, the size of a compressed TV-Anytime metadata instance is hardly smaller than that of an equivalent EIT in ATSC-PSIP or DVB-SI because the performance of Zlib is poor when strings are short, especially fewer than 100 characters. Since Zlib compression in TV-Anytime is executed on each TV-Anytime fragment that is a small data unit such as a title of a segment or a description of a director, good performance of Zlib can not generally be expected. MPEG-7

Motion Picture Expert Group—Standard 7 (MPEG-7), formally named “Multimedia Content Description Interface,” is the standard that provides a rich set of tools to describe multimedia content. MPEG-7 offers a comprehensive set of audiovisual description tools for the elements of metadata and their structure and relationships), enabling the effective and efficient access (search, filtering and browsing) to multimedia content. MPEG-7 uses XML schema language as the Description Definition Language (DDL) to define both descriptors and description schemes. Parts of MPEG-7 specification such as user history are incorporated in TV Anytime specification.

Generating Visual Rhythm

Visual Rhythm (VR) is a known technique whereby video is sub-sampled, frame-by-frame, to produce a single image (visual timeline) which contains (and conveys) information about the visual content of the video. It is useful, for example, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. Each vertical slice of visual rhythm with a single pixel width is obtained from each frame by sampling a subset of pixels along the predefined path. In this manner, the visual rhythm image contains patterns or visual features that allow the viewer/operator to distinguish and classify many different types of video effects, (edits and otherwise) including: cuts, wipes, dissolves, fades, camera motions, object motions, flashlights, zooms, and so forth. The different video effects manifest themselves as different patterns on the visual rhythm image. Shot boundaries and transitions between shots can be detected by observing the visual rhythm image which is produced from a video. Visual Rhythm is further described in commonly-owned, copending U.S. patent application Ser. No. 09/911,293 filed Jul. 23, 2001 (Publication No. 2002/0069218).

Interactive TV

The interactive TV is a technology combining various mediums and services to enhance the viewing experience of the TV viewers. Through two-way interactive TV, a viewer can participate in a TV program in a way that is intended by content/service providers, rather than the conventional way of passively viewing what is displayed on screen as in analog TV. Interactive TV provides a variety of kinds of interactive TV applications such as news tickers, stock quotes, weather service and T-commerce. One of the open standards for interactive digital TV is Multimedia Home Platform (MHP) (in the united states, MHP has its equivalent in the Java-Based Advanced Common Application Platform (ACAP), and Advanced Television Systems Committee (ATSC) activity and in OCAP, the Open Cable Application Platform specified by the OpenCable consortium) which provides a generic interface between the interactive digital applications and the terminals (for example, DVR) that receive and run the applications. A content producer produces an MHP application written mostly in JAVA using a set of MHP Application Program Interface (API) set. The MHP API set contains various API sets for primitive MPEG access, media control, tuner control, graphics, communications and so on. MHP broadcasters and network operators then are responsible for packaging and delivering the MHP application created by the content producer such that it can be delivered to the users having MHP compliant digital appliances or STBs. MHP applications are delivered to SBTs by inserting the MHP-based services into the MPEG-2 TS in the form of Digital Storage Media-Command and Control (DSM-CC) object carousels. A MHP compliant DVR then receives and process the MHP application in the MPEG-2 TS with a Java virtual machine.

Real-Time Indexing of TV Programs

A scenario, called “quick metadata service” on live broadcasting, is described in the above-referenced U.S. patent application Ser. No. 10/369,333 filed Feb. 19, 2003 and U.S. patent application Ser. No. 10/368,304 filed Feb. 18, 2003, where descriptive metadata of a broadcast program is also delivered to a DVR while the program is being broadcast and recorded. In the case of live broadcasting of sports games such as football, television viewers may want to selectively view and review highlight events of a game as well as plays of their favorite players while watching the live game. Without the metadata describing the program, it is not easy for viewers to locate the video segments corresponding to the highlight events or objects (for example, players in case of sports games or specific scenes or actors, actresses in movies) by using conventional controls such as fast forwarding.

As disclosed herein, the metadata includes time positions such as start time positions, duration and textual descriptions for each video segment corresponding to semantically meaningful highlight events or objects. If the metadata is generated in real-time and incrementally delivered to viewers at a predefined interval or whenever new highlight event(s) or object(s) occur or whenever broadcast, the metadata can then be stored at the local storage of the DVR or other device for a more informative and interactive TV viewing experience such as the navigation of content by highlight events or objects. Also, the entirety or a portion of the recorded video may be re-played using such additional data. The metadata can also be delivered just one time immediately after its corresponding broadcast television program has finished, or successive metadata materials may be delivered to update, expand or correct the previously delivered metadata. Alternatively, metadata may be delivered prior to broadcast of an event (such as a pre-recorded movie) and associated with the program when it is broadcast. Also, various combinations of pre-, post-, and during broadcast delivery of metadata are hereby contemplated.

One of the key components for the quick metadata service is a real-time indexing of broadcast television programs. Various methods have been proposed for video indexing, such as U.S. Pat. No. 6,278,446 (“Liou”) which discloses a system for interactively indexing and browsing video; and, U.S. Pat. No. 6,360,234 (“Jain”) which discloses a video cataloger system.

The various conventional methods can, at best, generate low-level metadata by decoding closed-caption texts, detecting and clustering shots, selecting key frames, attempting to recognize faces or speech, all of which could perhaps synchronized with video. However, with the current state-of-art technologies on image understanding and speech recognition, it is very difficult to accurately detect highlights and generate semantically meaningful and practically usable highlight summary of events or objects in real-time for many compelling reasons:

First, as described earlier, it is difficult to automatically recognize diverse semantically meaningful highlights. For example, a keyword “touchdown” can be identified from decoded closed-caption texts in order to automatically find touchdown highlights, resulting in numerous false alarms. Therefore, according to this disclosure, generating semantically meaningful and practically usable highlights still require the intervention of a human or other complex analysis system operator, usually after broadcast, but preferably during broadcast (usually slightly delayed from the broadcast event) for a first, rough, metadata delivery. A more extensive metadata set(s) could be later provided and, of course, pre-recorded events could have rough or extensive metadata set(s) delivered before, during or after the program broadcast. The later delivered metadata set(s) may augment, annotate or replace previously-sent, later-sent metadata, as desired.

Second, the conventional methods do not provide an efficient way for manually marking distinguished highlights in real-time. Consider a case where a series of highlights occurs at short intervals. Since it takes time for a human operator to type in a title and extra textual descriptions of a new highlight, there might be a possibility of missing the immediately following events.

Media Localization

The media localization within a given temporal audio-visual stream or file has been traditionally described using either the byte location information or the media time information that specifies a time point in the stream. In other words, in order to describe the location of a specific video frame within an audio-visual stream, a byte offset (for example, the number of bytes to be skipped from the beginning of the video stream) has been used. Alternatively, a media time describing a relative time point from the beginning of the audio-visual stream has also been used. For example, in the case of a video-on-demand (VOD) through interactive Internet or high-speed network, the start and end positions of each audio-visual program is defined unambiguously in terms of media time as zero and the length of the audio-visual program, respectively, since each program is stored in the form of a separate media file in the storage at the VOD server and, further, each audio-visual program is delivered through streaming on each client's demand. Thus, a user at the client side can gain access to the appropriate temporal positions or video frames within the selected audio-visual stream as described in the metadata.

However, as for TV broadcasting, since a digital stream or analog signal is continuously broadcast, the start and end positions of each broadcast program are not clearly defined. Since a media time or byte offset are usually defined with reference to the start of a media file, it could be ambiguous to describe a specific temporal location of a broadcast program using media times or byte offsets in order to relate an interactive application or event, and then to access to a specific location within an audio-visual program.

One of the existing solutions to achieve the frame accurate media localization or access in broadcast stream is to use PTS. The PTS is a field that may be present in a PES packet header as defined in MPEG-2, which indicates the time when a presentation unit is presented in the system target decoder. However, the use of PTS alone is not enough to provide a unique representation of a specific time point or frame in broadcast programs since the maximum value of PTS can only represent the limited amount of time that corresponds to approximately 26.5 hours. Therefore, additional information will be needed to uniquely represent a given frame in broadcast streams. On the other hand, if a frame accurate representation or access is not required, there is no need for using PTS and thus the following issues can be avoided: The use of PTS requires parsing of PES layers, and thus it is computationally expensive. Further, if a broadcast stream is scrambled, the descrambling process is needed to access to the PTS. The MPEG-2 System specification contains an information on a scrambling mode of the TS packet payload, indicating the PES contained in the payload is scrambled or not. Moreover, most of digital broadcast streams are scrambled, thus a real-time indexing system cannot access the stream in frame accuracy without an authorized descrambler if a stream is scrambled.

Another existing solution for media localization in broadcast programs is to use MPEG-2 DSM-CC Normal Play Time (NPT) that provides a known time reference to a piece of media. MPEG-2 DSM-CC NPT is more fully described at “ISO/IEC 13818-6, Information technology—Generic coding of moving pictures and associated audio information—Part 6: Extensions for DSM-CC” (see World Wide Web at iso.org). For applications of TV-Anytime metadata in DVB-MHP broadcast environment, it was proposed that the NPT should be used for the purpose of time description, more fully described at “ETSI TS 101 812: DVB Multimedia Home Platform (MHP) Specification” (see World Wide Web at etsi.org) and “MyTV: A practical implementation of TV-Anytime on DVB and the Internet” (International Broadcasting Convention, 2001) by A. McPrland, J. Morris, M. Leban, S. Rarnall, A. Hickman, A. Ashley, M. Haataja, F. deJong. In the proposed implementation, however, it is required that both head ends and receiving client device can handle NPT properly, thus resulting in highly complex controls on time.

Schemes for authoring metadata, video indexing/navigation and broadcast monitoring are known. Examples of these can be found in U.S. Pat. No. 6,357,042, U.S. patent application Ser. No. 10/756,858 filed Jan. 10, 2001 (Pub. No. US 2001/0014210 A1), and U.S. Pat. No. 5,986,692.

Metadata Indexing and Delivery

Recently, DVRs began to penetrate TV households. With this new consumer device, television viewers can record broadcast programs into the local storage of their DVR in a digital video compression format such as MPEG-2. A DVR allows television viewers to watch programs in the way they want and when they want. Due to the nature of digitally recorded video, viewers now have the capability of directly accessing a certain point of recorded programs in addition to the traditional VCR controls such as fast forward and rewind.

Furthermore, if segmentation metadata for a recorded AV program/stream is available, viewers can browse the program by selecting some predefined video segments within the recorded program, and by playing segments as well as a summary of the recorded program(s). As used herein, segmentation is the ability to define, access, and manipulate temporal intervals (i.e., segments) within an AV including visual with or without audio data, often with additional data, such as text information stream. The segmentation metadata of the recorded program can be delivered to a DVR by TV service providers or third-party service providers through the broadcasting network or interactive network or the like. The delivered metadata can be stored in a local storage of DVR for later use by viewers. The metadata can be described in proprietary formats or in international open standard specifications, such as MPEG-7 or TV-Anytime.

### GLOSSARY

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:
ACAP Advanced Common Application Platform (ACAP) is the result of harmonization of the CableLabs OpenCable (OCAP) standard and the previous DTV Application Software Environment (DASE) specification of the Advanced Television Systems Committee (ATSC). A more extensive explanation of ACAP may be found at “Candidate Standard: Advanced Common Application Platform (ACAP)” (see World Wide Web at atsc.org).
API Application Program Interface (API) is a set of software calls and routines that can be referenced by an application program as means for providing an interface between two software applications. An explanation and examples of an API may be found at “Dan Appleman's Visual Basic Programmer's guide to the Win32 API” (Sams, February, 1999) by Dan Appleman.
ATSC Advanced Television Systems Committee, Inc. (ATSC) is an international, non-profit organization developing voluntary standards for digital television. Countries such as U.S. and Korea adopted ATSC for digital broadcasting. A more extensive explanation of ATSC may be found at “ATSC Standard A/53C with Amendment No. 1: ATSC Digital Television Standard, Rev. C,” (see World Wide Web at atsc.org). More description may be found in “Data Broadcasting: Understanding the ATSC Data Broadcast Standard” (McGraw-Hill Professional, April 2001) by Richard S.

Chernock, Regis J. Crinon, Michael A. Dolan, Jr., John R. Mick; and may also be available in “Digital Television, DVB-T COFDM and ATSC 8-VSB” (Digitaltvbooks.com, October 2000) by Mark Massel. Alternatively, Digital Video Broadcasting (DVB) is an industry-led consortium committed to designing global standards that were adopted in European and other countries, for the global delivery of digital television and data services.
AV Audiovisual.
AVC Advanced Video Coding (H.264) is newest video coding standard of the ITU-T Video Coding Experts Group and the ISO/IEC Moving Picture Experts Group. An explanation of AVC may be found at “Overview of the H.264/AVC video coding standard”, Wiegand, T., Sullivan, G J., Bjntegaard, G., Luthra, A., Circuits and Systems for Video Technology, IEEE Transactions on , Volume: 13 , Issue: 7 , July 2003, Pages: 560-576; another may be found at “ISO/IEC 14496-10: Information technology—Coding of audio-visual objects—Part 10: Advanced Video Coding” (see World Wide Web at iso.org); Yet another description is found in “H.264 and MPEG-4 Video Compression” (Wiley) by lain E. G. Richardson, all three of which are incorporated herein by reference. MPEG-1 and MPEG-2 are alternatives or adjunct to AVC and are considered or adopted for digital video compression.
BIFS Binary Format for Scene is a scene graph in the form of hierarchical structure describing how the video objects should be composed to form a scene in MPEG-4. A more extensive information of BIFS may be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.
BiM Binary Metadata (BiM) Format for MPEG-7. A more extensive explanation of BiM may be found at “ISO/IEC 15938-1: Multimedia Context Description Interface—Part 1 Systems” (see World Wide Web at iso.ch).
BNF Backus Naur Form (BNF) is a formal metadata syntax to describe the syntax and grammar of structure languages such as programming languages. A more extensive explanation of BNF may be found at “The World of Programming Languages” (Springer-Verlag 1986) by M. Marcotty & H. Ledgard.
bslbf bit string, left-bit first. The-bit string is written as a string of 1s and 0s in the left order first. A more extensive explanation of bslbf may be found at may be found at “Generic Coding of Moving Pictures and Associated Audio Information—Part 1: Systems,” ISO/IEC 13818-1 (MPEG-2), 1994 (http://iso.org).
CA Conditional Access (CA) is a system utilized to prevent unauthorized users to access contents such as video, audio and so forth such that it ensures that viewers only see those programs they have paid to view. A more extensive explanation of CA may be found at “Conditional access for digital TV: Opportunities and challenges in Europe and the US” (2002) by MarketResearch.com.

CAT Conditional Access Table (CAT) is a table which provides information on the conditional access systems used in the multiplexed data stream. A more extensive explanation of CAT may be found at “ETSI EN 300 468 Digital Video Broadcasting (DVB); Specification for Service Information (SI) in DVB systems,” (see World Wide Web at etsi.org).
CC-text Closed Captions text (CC-text) is a text version of the spoken part of a television, movie, or computer presentation mainly developed to aid hearing-impaired people. Such text may be in various languages or using various character sets and may be switched between different options or disabled (not viewed).
CDMA Code Division Multiple Access
codec enCOder/DECoder is a short word for the encoder and the decoder. The encoder is a device that encodes data for the purpose of achieving data compression. Compressor is a word used alternatively for encoder. The decoder is a device that decodes the data that is encoded for data compression. Decompressor is a word alternatively used for decoder. Codecs may also refer to other types of coding and decoding devices.
COFDM Coded Octal frequency division multiplex (COFDM) is a modulation scheme used predominately in Europe and is supported by the Digital Video Broadcasting (DVB) set of standards. In the U.S., the Advanced Television Standards Committee (ATSC) has chosen 8-VSB (8-level Vestigial Sideband) as its equivalent modulation standard. A more extensive explanation on COFDM may be found at “Digital Television, DVB-T COFDM and ATSC 8-VSB” (Digitaltvbooks.com, October 2000) by Mark Massel.
CRC Cyclic Redundancy Check (CRC) is a 32-bit value to check if an error has occurred in a data during transmission, it is further explained in Annex A of ISO/IEC 13818-1. (see World Wide Web at iso.org).
CRID Content Reference IDentifier (CRID) is an identifier devised to bridge between the metadata of a program and the location of the program distributed over a variety of networks. A more extensive explanation of CRID may be found at “Specification Series: S-4 On: Content Referencing” (http://tv-anytime.org).
DAB Digital Audio Broadcasting (DAB) on terrestrial networks providing Compact Disc (CD) quality sound, text, data, and videos on the radio. A more detailed explanation of DAB may be found on the World Wide Web at worlddab.org/about.aspx. A more detailed description may also be found in “Digital Audio Broadcasting: Principles and Applications of Digital Radio” (John Wiley and Sons, Ltd.) by W. Hoeg, Thomas Lauterbach.
DASE DTV Application Software Environment (DASE) is a standard of ATSC that defines a platform for advanced functions in digital TV receivers such as a set top box. A more extensive explanation of DASE may be found at “ATSC Standard A/100: DTV Application Software Environment—Level 1 (DASE-1)” (see World Wide Web at atsc.org).
DCT Discrete Cosine Transform (DCT) is a transform function from spatial domain to frequency domain, a type of transform coding. A more extensive explanation of DCT may be found at “Discrete-Time Signal Processing” (Prentice Hall, 2^{nd} edition, February 1999) by Alan V. Oppenheim, Ronald W. Schafer, John R. Buck. Wavelet transform is an alternative or adjunct to DCT for various compression standards such as JPEG-2000 and Advanced Video Coding. A more thorough description of wavelet may be found at “Introduction on Wavelets and Wavelets Transforms” (Prentice Hall, 1^{st} edition, August 1997)) by C. Sidney Burrus, Ramesh A. Gopinath. DCT may be combined with Wavelet, and other transformation functions, such as for video compression, as in the MPEG 4 standard, more fully describes at “H.264 and MPEG-4 Video Compression” ( John Wiley & Sons, August 2003) by Iain E. G. Richardson and “The MPEG-4 Book” (Prentice Hall, July 2002) by Touradj Ebrahimi, Fernando Pereira.

DDL Description Definition Language (DDL) is a language that allows the creation of new Description Schemes and, possibly, Descriptors, and also allows the extension and modification of existing Description Schemes. An explanation on DDL may be found at “Introduction to MPEG 7: Multimedia Content Description Language” (John Wiley & Sons, June 2002) by B. S. Manjunath, Philippe Salembier, and Thomas Sikora. More generally, and alternatively, DDL can be interpreted as the Data Definition Language that is used by the database designers or database administrator to define database schemas. A more extensive explanation of DDL may be found at “Fundamentals of Database Systems” (Addison Wesley, July 2003) by R. Elmasri and S. B. Navathe.

DirecTV DirecTV is a company providing digital satellite service for television. A more detailed explanation of DirecTV may be found on the World Wide Web at directv.com/. Dish Network (see World Wide Web at dishnetwork.com), Voom (see World Wide Web at voom.com), and SkyLife (see World Wide Web at skylife.co.kr) are other companies providing alternative digital satellite service.
DMB Digital Multimedia Broadcasting (DMB), first commercialized in Korea, is a new multimedia broadcasting service providing CD-quality audio, video, TV programs as well as a variety of information (for example, news, traffic news) for portable (mobile) receivers (small TV, PDA and mobile phones) that can move at high speeds.
DRR Digital Radio Recorder
DSM-CC Digital Storage Media—Command and Control (DSM-CC) is a standard developed for the delivery of multimedia broadband services. A more extensive explanation of DSM-CC may be found at “ISO/IEC 13818-6, Information technology—Generic coding of moving pictures and associated audio information—Part 6: Extensions for DSM-CC” (see World Wide Web at iso.org).
DSS Digital Satellite System (DSS) is a network of satellites that broadcast digital data. An example of a DSS is DirecTV, which broadcasts digital television signals. DSS's are expected to become more important especially as TV and computers converge into a combined or unitary medium for information and entertainment (see World Wide Web at webopedia.com).
DTS Decoding Time Stamp (DTS) is a time stamp indicating the intended time of decoding. A more complete explanation of DTS may be found at “Generic Coding of Moving Pictures and Associated Audio Information—Part 1: Systems” ISO/IEC 13818-1 (MPEG-2), 1994 (http://iso.org).
DTV Digital Television (DTV) is an alternative audio-visual display device augmenting or replacing current analog television (TV) characterized by receipt of digital, rather than analog, signals representing audio, video and/or related information. Video display devices include Cathode Ray Tube (CRT), Liquid Crystal Display (LCD), Plasma and various projection systems. Digital Television is more fully described at “Digital Television: MPEG-1, MPEG-2 and Principles of the DVB System” (Butterworth-Heinemann, June, 1997) by Herve Beoit.
DVB Digital Video Broadcasting is a specification for digital television broadcasting mainly adopted in various countered in Europe adopt. A more extensive explanation of DVB may be found at “DVB: The Family of International Standards for Digital Video Broadcasting” by Ulrich Reimers (see World Wide Web at dvb.org). ATSC is an alternative or adjunct to DVB and is considered or adopted for digital broadcasting used in many countries such as the U.S. and Korea.
DVD Digital Video Disc (DVD) is a high capacity CD-size storage media disc for video, multimedia, games, audio and other applications. A more complete explanation of DVD may be found at “An Introduction to DVD Formats” (see World Wide Web at disctronics.co.uk/downloads/tech_docs/dvdintroduction.pdf) and “Video Discs Compact Discs and Digital Optical Discs Systems” (Information Today, June 1985) by Tony Hendley. CD (Compact Disc), minidisk, hard drive, magnetic tape, circuit-based (such as flash RAM) data storage medium are alternatives or adjuncts to DVD for storage, either in analog or digital format.
DVI Digital Visual Interface
DVR Digital Video Recorder (DVR) is usually considered a STB having recording capability, for example in associated storage or in its local storage or hard disk A more extensive explanation of DVR may be found at “Digital Video Recorders: The Revolution Remains On Pause” (MarketResearch.com, April 2001) by Yankee Group.
EIT Event Information Table (EIT) is a table containing essential information related to an event such as the start time, duration, title and so forth on defined virtual channels. A more extensive explanation of EIT may be found at “ATSC Standard A/65B: Program and System Information Protocol for Terrestrial Broadcast and Cable,” Rev. B, 18 Mar. 2003 (see World Wide Web at atsc.org).
EPG Electronic Program Guide (EPG) provides information on current and future programs, usually along with a short description. EPG is the electronic equivalent of a printed television program guide.
ES Elementary Stream (ES) is a stream containing either video or audio data with a sequence header and subparts of a sequence. A more extensive explanation of ES may be found at “Generic Coding of Moving Pictures and Associated Audio Information—Part 1: Systems,” ISO/IEC 13818-1 (MPEG-2), 1994 (http://iso.org).
ETM Extended Text Message (ETM) is a string data structure used to represent a description in several different languages. A more extensive explanation on ETM may be found at “ATSC Standard A/65B: Program and System Information Protocol for Terrestrial Broadcast and Cable”, Rev. B, 18 Mar. 2003” (see World Wide Web at atsc.org).
ETT Extended Text Table (ETT) contains Extended Text Message (ETM) streams, which provide supplementary description of virtual channel and events when needed. A more extensive explanation of ETM may be found at “ATSC Standard A/65B: Program and System Information Protocol for Terrestrial Broadcast and Cable”, Rev. B, 18 Mar. 2003” (see World Wide Web at atsc.org).
FCC The Federal Communications Commission (FCC) is an independent United States government agency, directly responsible to Congress. The FCC was established by the Communications Act of 1934 and is charged with regulating interstate and international communications by radio, television, wire, satellite and cable. More information can be found at their website (see World Wide Web at fcc.gov/aboutus.html).
F/W Firmware (F/W) is a combination of hardware (H/W) and software(S/W), for example, a computer program embedded in state memory (such as a Programmable Read Only Memory (PROM)) which can be associated with an electrical controller device (such as a microcontroller or microprocessor) to operate (or “run) the program on an electrical device or system. A more extensive explanation may be found at “Embedded Systems Firmware Demystified” (CMP Books 2002) by Ed Sutter.
GPS Global Positioning Satellite (GPS) is a satellite system that provides three-dimensional position and time information. The GPS time is used extensively as a primary source of time. UTC (Universal Time Coordinates), NTP (Network Time Protocol) Program Clock Reference (PCR) and Modified Julian Date (MJD) are alternatives or adjuncts to GPS Time and is considered or adopted for providing time information.
GUI Graphical User Interface (GUI) is a graphical interface between an electronic device and the user using elements such as windows, buttons, scroll bars, images, movies, the mouse and so forth.
HDMI High-Definition Multimedia Interface
HDTV High Definition Television (HDTV) is a digital television which provides superior digital picture quality (resolution). The 1080i (1920×1080 pixels interlaced), 1080p (1920×1080 pixels progressive) and 720p (1280×720 pixels progressive formats in a 16:9 aspect ratio are the commonly adopted acceptable HDTV formats. The “interlaced” or “progressive” refers to the scanning system of HDTV which are explained in more detail in “ATSC Standard A/53C with Amendment No. 1: ATSC Digital Television Standard”, Rev. C, 21 May 2004 (see World Wide Web at atsc.org).
Huffman Coding Huffman coding is a data compression method which may be used alone or in combination with other transformations functions or encoding algorithms (such as DCT, Wavelet, and others) in digital imaging and video as well as in other areas. A more extensive explanation of Huffman coding may be found at “Introduction to Data Compression” (Morgan Kaufmann, Second Edition, February, 2000) by Khalid Sayood.
H/W Hardware (H/W) is the physical components of an electronic or other device. A more extensive explanation on H/W may be found at “The Hardware Cyclopedia” (Running Press Book, 2003) by Steve Ettlinger.
JPEG JPEG (Joint Photographic Experts Group) is a standard for still image compression. A more extensive explanation of JPEG may be found at “ISO/IEC International Standard 10918-1” (see World Wide Web at jpeg.org/jpeg/). Various MPEG, Portable Network Graphics (PNG), Graphics Interchange Format (GIF), XBM (X Bitmap Format), Bitmap (BMP) are alternatives or adjuncts to JPEG and is considered or adopted for various image compression(s).
key frame Key frame (key frame image) is a single, still image derived from a video program comprising a plurality of images. A more extensive information of key frame may be found at “Efficient video indexing scheme for content-based retrieval” (Transactions on Circuit and System for Video Technology, April, 2002)” by Hyun Sung Chang, Sanghoon Sull, Sang U k Lee.
IP Internet Protocol, defined by IETF RFC791, is the communication protocol underlying the internet to enable computers to communicate to each other. An explanation on IP may be found at IETF RFC 791 Internet Protocol Darpa Internet Program Protocol Specification. (see World Wide Web at ietf.org/rfc/rfc0791.txt)
ISO International Organization for Standardization (ISO) is a network of the national standards institutes in charge of coordinating standards. More information can be found at their website (see World Wide Web at iso.org).
ITU-T International Telecommunication Union (ITU) Telecommunication Standardization Sector (ITU-T) is one of three sectors of the ITU for defining standards in the field of telecommunication. More information can be found at their website (see World Wide Web at itu.int/ITU-T).
LAN Local Area Network (LAN) is a data communication network spanning a relatively small area. Most LANs are confined to a single building or group of buildings. However, one LAN can be connected to other LANs over any distance, for example, via telephone lines and radio wave and the like to form Wide Area Network (WAN). More information can be found by at “Ethernet: The Definitive Guide” (O'Reilly & Associates) by Charles E. Spurgeon.
MHz (Mhz) A measure of signal frequency expressing millions of cycles per second.
MGT Master Guide Table (MGT) provides information about the tables that comprise the PSIP. For example, MGT provides the version number to identify tables that need to be updated, the table size for memory allocation and packet identifiers to identify the tables in the Transport Stream. A more extensive explanation of MGT may be found at “ATSC Standard A/65B: Program and System Information Protocol for Terrestrial Broadcast and Cable”, Rev. B, 18 March 2003 (see World Wide Web at atsc.org).
MHP Multimedia Home Platform (MHP) is a standard interface between interactive digital applications and the terminals. A more extensive explanation of MHP may be found at “ETSI TS 102 812: DVB Multimedia Home Platform (MHP) Specification” (see World Wide Web at etsi.org). Open Cable Application Platform (OCAP), Advanced Common Application Platform (ACAP), Digital Audio Visual Council (DAVIC) and Home Audio Video Interoperability (HAVi) are alternatives or adjuncts to MHP and are considered or adopted as interface options for various digital applications.
MJD Modified Julian Date (MJD) is a day numbering system derived from the Julian calendar date. It was introduced to set the beginning of days at 0 hours, instead of 12 hours and to reduce the number of digits in day numbering. UTC (Universal Time Coordinates), GPS (Global Positioning Systems) time, Network Time Protocol (NTP) and Program Clock Reference (PCR) are alternatives or adjuncts to PCR and are considered or adopted for providing time information.
MP3 Moving Picture Expert Group (MPEG) Audio Layer-3 (MP3) is a coding standard for compression of audio data.
MPEG The Moving Picture Experts Group is a standards organization dedicated primarily to digital motion picture encoding in Compact Disc. For more information, see their web site at (see World Wide Web at mpeg.org).
MPEG-2 Moving Picture Experts Group—Standard 2 (MPEG-2) is a digital video compression standard designed for coding interlaced/noninterlaced frames. MPEG-2 is currently used for DTV broadcast and DVD. A more extensive explanation of MPEG-2 may be found on the World Wide Web at mpeg.org and “Digital Video: An Introduction to MPEG-2 (Digital Multimedia Standards Series)” (Springer, December, 1996) by Barry G Haskell, Atul Puri, Arun N. Netravali.
MPEG-4 Moving Picture Experts Group—Standard 4 (MPEG-4) is a video compression standard supporting interactivity by allowing authors to create and define the media objects in a multimedia presentation, how these can be synchronized and related to each other in transmission, and how users are to be able to interact with the media objects. A more extensive information of MPEG-4 can be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.
MPEG-7 Moving Picture Experts Group—Standard 7 (MPEG-7), formally named “Multimedia Content Description Interface” (MCDI) is a standard for describing the multimedia content data. More extensive information about MPEG-7 can be found at the MPEG home page (http://mpeg.tilab.com), the MPEG-7 Consortium website (see World Wide Web at mp7c.org), and the MPEG-7 Alliance website (see World Wide Web at mpeg-industry.com) as well as “Introduction to MPEG 7: Multimedia Content Description Language” (John Wiley & Sons, June, 2002) by B. S. Manjunath, Philippe Salembier, and Thomas Sikora, and “ISO/IEC 15938-5:2003 Information technology—Multimedia content description interface—Part 5: Multimedia description schemes” (see World Wide Web at iso.ch).
NPT Normal Playtime (NPT) is a time code embedded in a special descriptor in a MPEG-2 private section, to provide a known time reference for a piece of media. A more extensive explanation of NPT may be found at “ISO/IEC 13818-6, Information Technology—Generic Coding of Moving Pictures and Associated Audio Information—Part 6: Extensions for DSM-CC” (see World Wide Web at iso.org).
NTP Network Time Protocol (NTP) is a protocol that provides a reliable way of transmitting and receiving the time over the Transmission Control Protocol/Internet Protocol (TCP/IP) networks. A more extensive explanation of NTP may be found at “RFC (Request for Comments) 1305 Network Time Protocol (Version 3) Specification” (see World Wide Web at faqs.org/rfcs/rfc1305.html). UTC (Universal Time Coordinates), GPS (Global Positioning Systems) time, Program Clock Reference (PCR) and Modified Julian Date (MJD) are alternatives or adjuncts to NTP and are considered or adopted for providing time information.
NTSC The National Television System Committee (NTSC) is responsible for setting television and video standards in the United States (in Europe and the rest of the world, the dominant television standards are PAL and SECAM). More information is available by viewing the tutorials on the World Wide Web at ntsc-tv.com.
OpenCable The OpenCable managed by CableLabs, is a research and development consortium to provide interactive services over cable. More information is available by viewing their website on the World Wide Web at opencable.com.
PC Personal Computer (PC).
PCR Program Clock Reference (PCR) in the Transport Stream (TS) indicates the sampled value of the system time clock that can be used for the correct presentation and decoding time of audio and video. A more extensive explanation of PCR may be found at “Generic Coding of Moving Pictures and Associated Audio Information-Part 1: Systems,” ISO/IEC 13818-1 (MPEG-2), 1994 (http://iso.org). SCR (System Clock Reference) is an alternative or adjunct to PCR used in MPEG program streams.
PDA Personal Digital Assistant.
PES Packetized Elementary Stream (PES) is a stream composed of a PES packet header followed by the bytes from an Elementary Stream (ES). A more extensive explanation of PES may be found at “Generic Coding of Moving Pictures and Associated Audio Information—Part 1: Systems,” ISO/IEC 13818-1 (MPEG-2), 1994 (http://iso.org).
PID A Packet Identifier (PID) is a unique integer value used to identify Elementary Streams (ES) of a program or ancillary data in a single or multi-program Transport Stream (TS). A more extensive explanation of PID may be found at “Generic Coding of Moving Pictures and Associated Audio Information—Part 1: Systems,” ISO/IEC 13818-1 (MPEG-2), 1994 (http://iso.org).
PMT A Program Map Table (PMT) is a table in MPEG which maps a program with the elements that compose a program (video, audio and so forth). A more extensive explanation of PMT may be found at Generic Coding of Moving Pictures and Associated Audio Information—Part 1: Systems,” ISO/IEC 13818-1 (MPEG-2), 1994 (http://iso.org).
PS Program Stream (PS), specified by the MPEG-2 System Layer, is used in relatively error-free environment such as DVD media. A more extensive explanation of PS may be found at “Generic Coding of Moving Pictures and Associated Audio Information—Part 1: Systems,” ISO/IEC 13818-1 (MPEG-2), 1994 (http://iso.org).
PSIP Program and System Information Protocol (PSIP) for ATSC data tables for delivering EPG information to consumer devices such as DVRs in countries using ATSC (such as the U.S. and Korea) for digital broadcasting. Digital Video Broadcasting System Information (DVB-SI) is an alternative or adjunct to ATSC-PSIP and is considered or adopted for Digital Video Broadcasting (DVB) used in Europe. A more extensive explanation of PSIP may be found at “ATSC Standard A/65B: Program and System Information Protocol for Terrestrial Broadcast and Cable,” Rev. B, 18 Mar. 2003 (see World Wide Web at atsc.org).
PTS Presentation Time Stamp (PTS) is a time stamp(s) that indicates the presentation time of audio and/or video. A more extensive explanation of PTS may be found at “Generic Coding of Moving Pictures and Associated Audio Information—Part 1: Systems,” ISO/IEC 13818-1 (MPEG-2), 1994 (http://iso.org).
PVR Personal Video Recorder (PVR) is a term that is commonly used interchangeably with DVR.
ReplayTV ReplayTV is a company leading DVR industry in maximizing users TV viewing experience. An explanation on ReplayTV may be found at http://digitalnetworksna.com, http://replaytvcom.
RF Radio Frequency (RF) refers to any frequency within the electromagnetic spectrum associated with radio wave propagation.
RRT A Rate Region Table (RRT) is a table providing program rating information in an ATSC standard. A more extensive explanation of RRT may be found at “ATSC Standard A/65B: Program and System Information Protocol for Terrestrial Broadcast and Cable,” Rev. B, 18 Mar. 2003 (see World Wide Web at atsc.org).
SCR System Clock Reference (SCR) in the Program Stream (PS) indicates the sampled value of the system time clock that can be used for the correct presentation and decoding time of audio and video. A more extensive explanation of SCR may be found at “Generic Coding of Moving Pictures and Associated Audio Information—Part 1: Systems,” ISO/IEC 13818-1 (MPEG-2), 1994 (http://iso.org). PCR (Program Clock Reference) is an alternative or adjunct to SCR.
SDTV Standard Definition Television (SDTV) is one mode of operation of digital television that does not achieve the video quality of HDTV, but are at least equal, or superior to, NTSC pictures. SDTV may usually have either 4:3 or 16:9 aspect ratios, and usually includes surround sound. Variations of frames per second (fps), lines of resolution and other factors of 480p and 480i make up the 12 SDTV formats in the ATSC standard. The 480p and 480i each represent 480 progressive and 480 interlaced format explained in more detail in ATSC Standard A/53C with Amendment No. 1: ATSC Digital Television Standard, Rev. C 21 May 2004 (see World Wide Web at atsc.org).
SGML Standard Generalized Markup Language (SGML) is an international standard for the definition of device and system independent methods of representing texts in electronic form. A more extensive explanation of SGML may be found at “Learning and Using SGML” (see World Wide Web at w3.org/MarkUp/SGML/), and at “Beginning XML” (Wrox, December, 2001) by David Hunter.
SI System Information (SI) for DVB (DVB-SI) provides EPG information data in DVB compliant digital TVs. A more extensive explanation of DVB-SI may be found at “ETSI EN 300 468 Digital Video Broadcasting (DVB); Specification for Service Information (SI) in DVB Systems”, (see World Wide Web at etsi.org). ATSC-PSIP is an alternative or adjunct to DVB-SI and is considered or adopted for providing service information to countries using ATSC such as the U.S. and Korea.
STB Set-top Box (STB) is a display, memory, or interface devices intended to receive, store, process, repeat, edit, modify, display, reproduce or perform any portion of a program, including personal computer (PC) and mobile device.
STT System Time Table (STT) is a small table defined to provides the time and date information in ATSC. Digital Video Broadcasting (DVB) has a similar table called a Time and Date Table (TDT). A more extensive explanation of STT may be found at “ATSC Standard A/65B: Program and System Information Protocol for Terrestrial Broadcast and Cable”, Rev. B, 18 Mar. 2003 (see World Wide Web at atsc.org).
S/W Software is a computer program or set of instructions which enable electronic devices to operate or carry out certain activities. A more extensive explanation of S/W may be found at “Concepts of Programming Languages” (Addison Wesley) by Robert W. Sebesta.
TCP Transmission Control Protocol (TCP) is defined by the Internet Engineering Task Force (IETF) Request for Comments (RFC) 793 to provide a reliable stream delivery and virtual connection service to applications. A more extensive explanation of TCP may be found at “Transmission Control Protocol Darpa Internet Program Protocol Specification” (see World Wide Web at ietf.org/rfc/rfc0793.txt).
TDT Time Date Table (TDT) is a table that gives information relating to the present time and date in Digital Video Broadcasting (DVB). STT is an alternative or adjunct to TDT for providing time and date information in ATSC. A more extensive explanation of TDT may be found at “ETSI EN 300 468 Digital Video Broadcasting (DVB); Specification for Service Information (SI) in DVB systems” (see World Wide Web at etsi.org).
TiVo TiVo is a company providing digital content via broadcast to a consumer DVR it pioneered. More information on TiVo may be found at http://tivo.com.
TOC Table of contents herein refers to any listing of characteristics, locations, or references to parts and subparts of a unitary presentation (such as a book, video, audio, AV or other references or entertainment program or content) preferably for rapidly locating and accessing the particular part(s) or subpart(s) or segment(s) desired.
TS Transport Stream (TS), specified by the MPEG-2 System layer, is used in environments where errors are likely, for example, broadcasting network. TS packets into which PES packets are further packetized are 188 bytes in length. An explanation of TS may be found at “Generic Coding of Moving Pictures and Associated Audio Information—Part 1: Systems,” ISO/IEC 13818-1 (MPEG-2), 1994 (http://iso.org).
TV Television, generally a picture and audio presentation or output device; common types include cathode ray tube (CRT), plasma, liquid crystal and other projection and direct view systems, usually with associated speakers.
TV-Anytime TV-Anytime is a series of open specifications or standards to enable audio-visual and other data service developed by the TV-Anytime Forum. A more extensive explanation of TV-Anytime may be found at the home page of the TV-Anytime Forum (see World Wide Web at tv-anytime.org).
TVPG Television Parental Guidelines (TVPG) are guidelines that give parents more information about the content and age-appropriateness of TV programs. A more extensive explanation of TVPG may be found on the World Wide Web at tvguidelines.org/default.asp.
uimsbf unsigned integer, most significant-bit first. The unsigned integer is made up of one or more 1s and 0s in the order of most significant-bit first (the left-most-bit is the most significant bit). A more extensive explanation of uimsbf may be found at may be found at “Generic Coding of Moving Pictures and Associated Audio Information—Part 1: Systems,” ISO/IEC 13818-1 (MPEG-2), 1994 (http://iso.org).
UTC Universal Time Coordinated (UTC), the same as Greenwich Mean time, is the official measure of time used in the world's different time zones.
VCR Video Cassette Recorder (VCR). DVR is digital alternatives or adjuncts to VCR.
VCT Virtual Channel Table (VCT) is a table which provides information needed for the navigating and tuning of a virtual channels in ATSC and DVB. A more extensive explanation of VCT may be found at “ATSC Standard A/65B: Program and System Information Protocol for Terrestrial Broadcast and Cable,” Rev. B, 18 Mar. 2003 (see World Wide Web at atsc.org).
VOD Video On Demand (VOD) is a service that enables television viewers to select a video program and have it sent to them over a channel via a network such as a cable or satellite TV network. A more extensive explanation may be found at
W3C The World Wide Web Consortium (W3C) is an organization developing various technologies to enhance the Web experience. More information on W3C may be found at World Wide Web at w3c.org.
XML eXtensible Markup Language (XML) defined by W3C (World Wide Web Consortium), is a simple, flexible text format derived from SGML. A more extensive explanation of XML may be found at “Extensible Markup Language (XML)” (see World Wide Web at w3.org/XML/).
XML Schema A schema language defined by W3C to provide means for defining the structure, content and semantics of XML documents. A more extensive explanation of XML Schema may be found at “XML Schema” (see World Wide Web at w3.org/XML/Schema#resources).
Zlib Zlib is a free, general-purpose lossless data-compression library for use independent of the hardware and software. More information can be obtained on the World Wide Web at gzip.org/zlib.

### BRIEF DESCRIPTION (SUMMARY)

Generally, the present disclosure provides techniques for the use of template, segment-mark and bookmark on the visual spatio-temporal pattern of an AV program during indexing.

Generally, the visual spatio-temporal pattern of an AV program is a “derivative” of the stream of images forming the AV program which greatly facilitates human or automatic detection of scene changes. Detecting scene changes is fundamental to indexing. The use of the visual spatio-temporal pattern in lieu of or in conjunction with viewing the AV program itself can greatly facilitate and speed up the process of indexing AV programs.

According to the techniques disclosed herein, a method of indexing an audio-visual (AV) program comprises: indexing an AV program with segmentation metadata, wherein a specific position and interval of the AV program are represented by a time-index; and using at least one technique selected from the group consisting of template, segment-mark and bookmark on a visual spatio-temporal pattern of an AV program during indexing to create a segment hierarchy. The segment hierarchy may comprise a tree view of segments for the AV program being indexed. A template of the segment hierarchy may comprise a pre-defined representative hierarchy of segments for AV programs.

According to the techniques disclosed herein, a graphical user interface (GUI) for a real time indexer for an AV program comprises: a visual spatio-temporal pattern; a segment-mark button; and a bookmark button. The GUI may further comprise one or more of: a list of consecutive frames; a segment hierarchy in textual description; a list of key frames at a same level of the segment tree hierarchy; an information panel; a AV/media player; and a template of a segment hierarchy.

According to the techniques disclosed herein, a method of indexing an AV program comprises: using a template of a segment hierarchy. The method may further comprise using a visual spatio-temporal pattern, and visually marking a position of interest on a spatio-temporal pattern. The method may also comprise automatically generating a new segment at a position of the segment hierarchy corresponding to a position of the template segment hierarchy.

According to the techniques disclosed herein, a method of reusing segmentation metadata for a given AV program delivered at a different times on a same broadcasting channel or on different broadcasting channels, or via different types of delivery networks comprises: adjusting the time-indices in segmentation metadata for the AV program; and delivering the segmentation metadata; wherein a specific position of the AV program in the segmentation metadata is represented by a time-index. Adjusting the time-indices may comprise transforming time-indices into broadcasting times. Adjusting the time-indices may comprise transforming time-indices into media times relative to a broadcasting time of the start of the AV program.

Other objects, features and advantages of the techniques disclosed herein will become apparent from the ensuing descriptions thereof.

### BRIEF DESCRIPTION OF THE DRAWINGS

Reference will be made in detail to embodiments of the techniques disclosed herein, examples of which are illustrated in the accompanying drawings (figures). The drawings are intended to be illustrative, not limiting, and it should be understood that it is not intended to limit the techniques to the illustrated embodiments.

FIGS. 1A, 1B and 1C are block diagrams illustrating schemes for providing metadata service for live or pre-recorded broadcast AV programs.

FIGS. 2A and 2B are block diagrams illustrating real-time indexing systems for live broadcast AV programs.

FIG. 3A is an exemplary graphical user interface (GUI) for a real-time AV indexer.

FIG. 3B is an exemplary drawing for modeling operations which may be used to manipulate the segment hierarchy.

FIGS. 4A and 4B are exemplary drawings illustrating the advantage of marking on a visual time axis showing a visual spatio-temporal pattern over marking on time axis showing a simple time scale.

FIG. 5 is an exemplary 1-level metadata on the segment hierarchy for a program using broadcasting time.

FIG. 6A is a flow chart of an exemplary real-time indexing system for a digital/digitized AV program.

FIG. 6B is a flow chart showing the preprocessing referred to in FIG. 6A.

FIG. 6C is a flow chart showing the spatio-temporal pattern creation process referred to in FIG. 6A.

FIG. 6D is a flow chart showing an exemplary process, referred to in FIGS. 6A and 6E, of verifying and refining a given mark.

FIG. 6E is a flow chart showing the post-processing referred to in FIG. 6A.

FIG. 7 is a schematic view of showing a metadata delivery system according to an embodiment of the present disclosure.

FIGS. 8 and 9 are flow charts showing the processes according to the disclosure, in which FIG. 8 shows the content acquisition process and FIG. 9 a billing-to-payment process is an exemplary 1-level metadata on the segment hierarchy for a program using broadcasting time.

FIG. 10 is a block diagram showing an exemplary mobile device that has ability to record broadcast audio program in its memory such as flash memory or hard disk.

FIG. 11 is a flowchart showing the details of the procedure checking the reservation list to determine which program is to be recorded.

FIG. 12 is diagram showing an exemplary movement (hand off) of the mobile device that can be detected from the mobility support station to which the mobile device is connected.

### DETAILED DESCRIPTION

A variety of devices may be used to process and display delivered content(s), such as, for example, a STB which may be connected inside or associated with user's TV set. Typically, today's STB capabilities include receiving analog and/or digital signals from broadcasters who may provide programs in any number of channels, decoding the received signals and displaying the decoded signals.

Media Localization

To represent or locate a position in a broadcast program (or stream) that is uniquely accessible by both indexing systems and client DVRs is critical in a variety of applications including video browsing, commercial replacement, and information service relevant to specific frame(s). To overcome the existing problem in localizing broadcast programs, a solution is disclosed in the above-referenced U.S. patent application Ser. No. 10/369,333 using broadcasting time as a media locator for broadcast stream, which is a simple and intuitive way of representing a time line within a broadcast stream as compared with the methods that require the complexity of implementation of DSM-CC NPT in DVB-MHP and the non-uniqueness problem of the single use of PTS.

Broadcasting time is the current time a program is being aired for broadcast and it is disclosed herein methods for obtaining broadcasting time by utilizing information on time or position markers multiplexed and broadcast in MPEG-2 TS or other proprietary or equivalent transport packet structure by terrestrial DTV broadcast stations, satellite/cable DTV service providers, and DMB service providers. For example, techniques are disclosed to utilize the information on time-of-day carried in the broadcast stream in the system_time field in STT of ATSC/OpenCable (usually broadcast once every second) or in the UTC_time field in TDT of DVB (could be broadcast once every 30 seconds), respectively. For Digital Audio Broadcasting (DAB), DMB or other equivalents, the similar information on time-of-day broadcast in their TSs can be utilized. Additionally, if broadcasting time is required to have a frame-accuracy, PCR also multiplexed and broadcast is utilized. In this disclosure, such information on time-of-day carried in the broadcast stream (for example, the system_time field in STT or other equivalents described above) is collectively called “system time marker”.

An exemplary technique for obtaining broadcasting time for localizing a specific position or frame in a broadcast stream is to use a system_time field in STT (or UTC_time field in TDT or other equivalents) that is periodically broadcast. More specifically, the broadcasting time of a frame can be described and thus localized by using the closest (alternatively, the closest, but preceding the temporal position of the frame) system_time in STT from the time instant when the frame is to be presented or displayed according to its corresponding PTS in a video stream. Alternatively, the broadcasting time of a frame can be obtained by using the system_time in STT that is nearest from the bit stream position where the encoded data for the frame starts. It is noted that the single use of this system_time field usually does not allow the frame accurate access to a stream since the delivery interval of the STT is within 1 second and the system_time field carried in this STT is accurate within one second. Thus, a stream can be accessed only within one-second accuracy, which could be satisfactory in many practical applications. Note that although the broadcasting time of a frame obtained by using the system_time field in STT is accurate within one second, an arbitrary time before the localized frame position may be played to ensure that a specific frame is displayed. It is also noted that the information on broadcast STT or other equivalents should also be stored with the AV stream itself in order to utilize it later for localization.

Another method is disclosed to achieve (near) frame-accurate broadcasting time for a specific position or frame in a broadcast stream. A specific position or frame to be displayed is localized by using both system_time in STT (or UTC_time in TDT or other equivalents) as a time marker and relative time with respect to the time marker. More specifically, the localization to a specific position is achieved by using system_time in STT that is a preferably first-occurring and nearest one preceding the specific position or frame to be localized, as a time marker. Additionally, since the time marker used alone herein does not usually provide frame accuracy, the relative time of the specific position with respect to the time marker is also computed in the resolution of preferably at least or about 30 Hz by using a clock, such as PCR, STB's internal system clock if available with such accuracy, or other equivalents. Alternatively, the broadcasting time for a specific position may be achieved by interpolating or extrapolating the values of system_time in STT (or UTC_time in TDT or other equivalents) in the resolution of preferably at least or about 30 Hz by using a clock, such as PCR, STB's internal system clock if available with such accuracy, or other equivalents.

Another exemplary method for frame-accurate broadcasting time is to use both system_time field in STT (or UTC_time field in TDT or other equivalents) and PCR. The localization information on a specific position or frame to be displayed is achieved by using system_time in STT and the PTS for the position or frame to be described. Since the value of PCR usually increases linearly with a resolution of 27 MHz, it can be used for frame accurate access. Since the PCR is a 90 kHz clock represented by a 33-bit that increased linearly, it can be used for frame accurate access. However, since the PCR wraps back to zero when the maximum bit count is achieved, we should also utilize the system_time in STT that is a preferably nearest one preceding the PTS of the frame, as a time marker to uniquely identify the frame. It is also noted that the information on broadcast STT or other equivalents should also be stored with the AV stream itself in order to utilize it later for localization.

Metadata Generation and Delivery

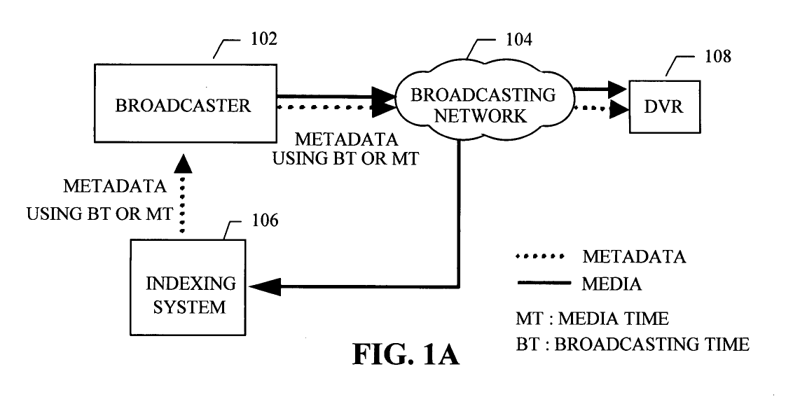

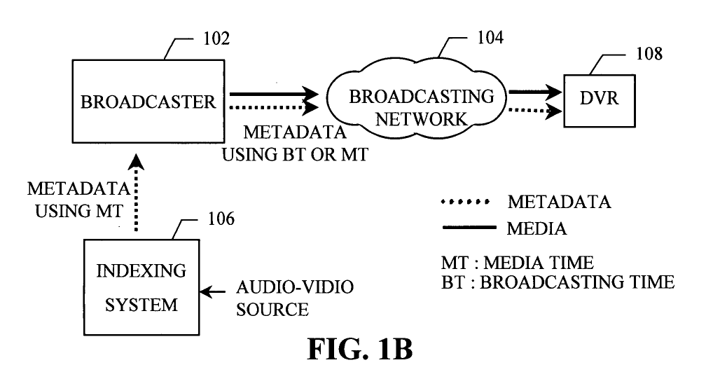

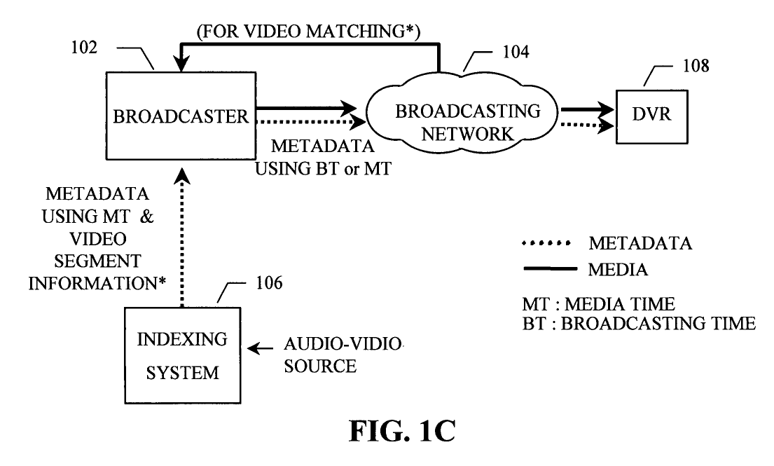

FIGS. 1A, 1B and 1C illustrates schemes for providing the metadata service for live or pre-recorded broadcast AV programs wherein like numerals denote like elements, showing how a DVR receives the broadcast AV program as well as its descriptive metadata.

FIG. 1A shows a scheme for indexing a broadcast AV program from a DTV broadcaster/service provider's headend 102 and then generating its metadata in real-time at an indexing system 106, for transmitting the metadata back to the headend, and for delivering the metadata to one or more DVRs 108 by multiplexing the metadata into the broadcast stream at the headend. An AV program is described by the segmentation metadata where a specific position and interval of the program are represented by a time-index. A time-index contained in the metadata can be represented by either broadcasting time, or its equivalent representation (for example, media time defined as the relative time from a reference time point wherein the start time of the program described in an EPG or the broadcasting time of the start of the AV program could be used as the reference time point for media time). In the scheme in shown FIG. 1A, the real-time indexing system 106 analyzes the current broadcast AV program, and generates its segmentation metadata that contains time-indices by associating each temporal position of the AV program with the broadcasting time. The metadata generated in real-time is transmitted back to the headend 102 and is delivered to DVRs 108, either partially or in whole, by inserting/multiplexing the metadata into the broadcast stream at the headend. Thus, the resulting broadcast stream delivered to a DVR preferably contains the AV program, its metadata, the broadcasting time information and the EPG. Thus, if the resulting broadcast stream is stored in a client DVR, users can later browse the program by directly accessing to a specific position or segment of the program pointed to by a time-index in the metadata, wherein the direct access can be efficiently implemented by obtaining the broadcasting time in the stored broadcast stream.

FIG. 1B illustrates a metadata service scheme for a pre-recorded broadcast AV program, wherein a program can be indexed to generate the segmentation metadata prior to broadcasting. (When a pre-recorded program is not indexed prior to broadcasting, the scheme in FIG. 1A can be applied.) The metadata is then transmitted to DVRs 108, partially or in whole, by inserting/multiplexing the metadata into the broadcast stream at the DTV headend 102. Thus, the resulting broadcast stream delivered to a DVR contains the AV program, its metadata, the broadcasting time information and the EPG. Thus, if the resulting broadcast stream is stored in a client DVR, users can later browse the program.

Notice that a time-index in the “original metadata” generated prior to broadcasting is usually represented by media time specifying a relative time from a reference time point that corresponds to the beginning of a pre-recorded program. Then, the start time of a program in an EPG can be used as a reference time point for media time. If the start time of the scheduled program in an EPG is different from the actual broadcast start time of the program, the EPG start time broadcast from the headend should be updated accordingly. Then, a time-index, if represented in media time, contained in the metadata received by a DVR can be transformed to the broadcasting time by adding the actual start time of the program in the EPG, allowing fast access to a position pointed to by the time-index by utilizing the broadcasting times obtained from the stored broadcast stream. Alternatively, the actual broadcast start time or a reference start time of a program can be included in the metadata, and the metadata is delivered to DVRs where a time-index contained in the delivered metadata, if represented in media time, can be transformed to the broadcasting time by adding the actual broadcast start time or a reference start time of the program also contained in the metadata.

Alternatively, all of the time-indices contained in the original metadata can be easily transformed into the corresponding actual broadcasting times by adding the actual broadcast start time, resulting in the “adjusted metadata”. This adjusted metadata is delivered to DVRs. It is also understood that all of the time-indices in the original metadata should also be adjusted according to the expected commercial and other breaks or interruption in the target program.

In the above paragraph, the actual start time of a program can be obtained by a program scheduler. Alternatively, FIG. 1C illustrates a scheme for estimating an accurate start time of a program by an adequate video matching technique. For example, a set of time durations of the consecutive shots of a video segment of a program used for indexing prior to broadcasting could be utilized to match with the corresponding video segment that is being broadcast. When the program starts to be broadcast, the broadcast program is analyzed at the headend 102 or somewhere else, a set of time durations of the consecutive shots of its video segment is generated, and the time-offset between the broadcast program and the program used for indexing is computed by comparing two sets of the durations. Alternatively, instead of using a set of the durations, a visual pattern matching technique might be used, where the spatio-temporal pattern of a video segment of the broadcast program is compared with that of the program used for indexing to determine the time-offset.

Once the segmentation metadata of an AV program is generated, such as by using one of the schemes shown in FIGS. 1A, 1B, 1C, for a particular type of broadcasting network such as terrestrial, the segmentation metadata can be reused for the same AV program delivered at a different time on the same broadcasting or different channel, or via different types of delivery networks such as satellite, cable, and Internet. For example, for the same AV program delivered via Internet VOD (Video On Demand, although other types may be used), a time-index represented by broadcasting time in the aforementioned metadata is transformed into media time by subtracting the actual start time of the program from the broadcasting time. Also, for the same AV program broadcast via different broadcasting networks such as satellite or cable broadcast systems, a time-index represented by broadcasting time in the aforementioned metadata is adjusted according to the start time of the program broadcast by each broadcasting network, wherein the start time of the program for each broadcasting network can be obtained as by from the program scheduler or an adequate video matching technique or other suitable means.

For all schemes shown in FIGS. 1A, 1B, 1C, the segmentation metadata is delivered to DVRs by carrying it on the MPEG-2 TS or other proprietary transport packet structure. More specifically, for example, there could be four exemplary ways for metadata delivery: First, the metadata can be transmitted to DVRs with the existing EPG data such as ATSC-PSIP and DVB-SI by attaching a new descriptor for the segmentation metadata to the existing EPG Second, the metadata can be transmitted to DVRs through the data broadcasting channel such as for DVB-MHP, ACAP and ATSC-ACAP (Advanced Common Application Platform). Third, the metadata can be transmitted to DVRs by defining a new packet ID (PID). Finally, the metadata can be transmitted to DVRs using the DSM-CC (digital storage media—command and control) sections carried by MPEG-2 PES (packetized elementary stream) packets. Alternatively, the metadata can be transmitted to DVRs through a back channel including such as Internet, Intranet, Public Switched Telephone Network, other LANs or WANs, and others.

Real-Time Indexing System for Digitized/Digital AV Stream

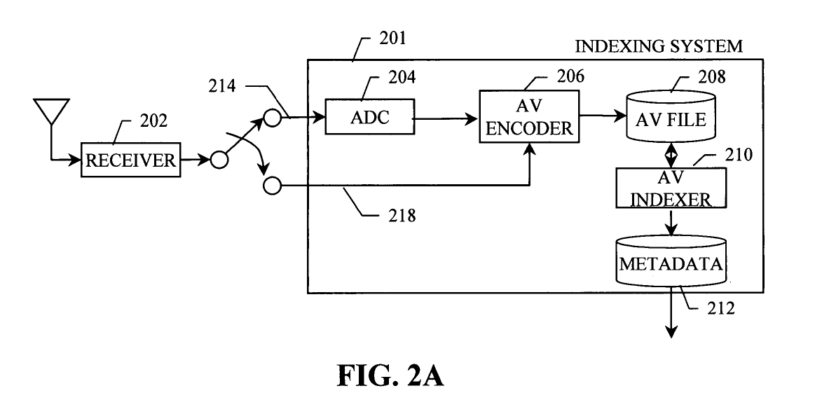

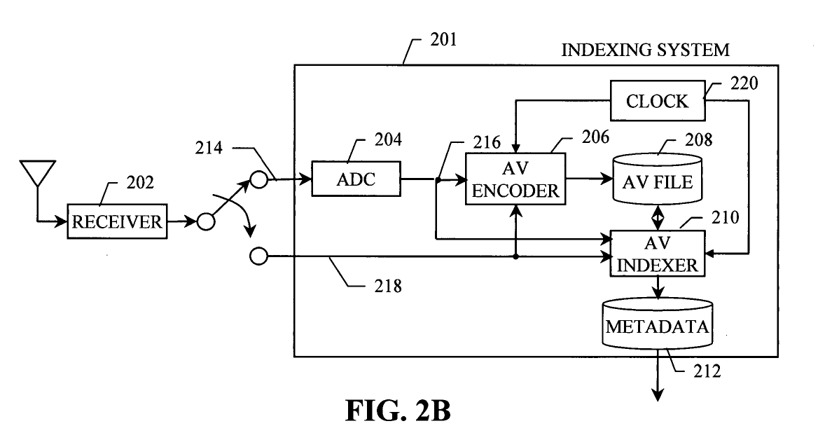

FIGS. 2A and 2B are block diagrams of two real-time indexing systems 201 for broadcast AV programs wherein like numerals indicate like elements. The broadcast AV program/stream is delivered and decoded in a receiver 202 such as a digital STB, and is output in the exemplary form of either analog signal (for example, composite video, left and right audio) or uncompressed digital signal such as Digital Visual Interface (DVI) and High-Definition Multimedia Interface (HDMI). An analog output 214 is first digitized by an Analog-to-Digital Converter (ADC) or frame capturer 204, and is encoded/compressed to a low-bit rate digital stream by the AV encoder 206 in order for a low-cost real-time indexer to easily deal with. Alternatively, a digital signal 218 from the receiver 202 is directly transferred to the encoder 206. The AV encoder 206 encodes a sequence of digital uncompressed raw frames from the ADC 204 or directly from the receiver 202. The encoded AV frames are incrementally stored in the local or associated data storage 208 as an AV file for the current broadcast AV program. The metadata for the current broadcast AV program is generated by the AV indexer 210 and is delivered to DVRs as shown in FIG. 1A. The metadata for pre-recorded AV broadcast programs can be also indexed similarly in off-line prior to broadcasting, and is delivered to DVRs as shown in FIGS. 1B and 1C.

In the first indexing system shown in FIG. 2A, the AV indexer 210 reads the AV file that is currently being written into the storage 208 by the encoder 206, generates metadata for the AV file that corresponds to the part of the AV program that has been broadcast, and stores it in the local storage 212. The process of generating the metadata for the AV file preferably involves the automatic steps of constructing a visual spatio-temporal pattern called a visual rhythm, detecting shot boundaries, and generating a key frame for each detected shot. An exemplary visual rhythm scheme is shown in the above-referenced U.S. patent application Ser. No. 10/365,576.

The AV file is also used to show the broadcast program to an indexing operator. Use of a visual spatio-temporal pattern allows an indexing operator to easily verify the correctness of the result of automatic shot boundary detection by visually checking the spatio-temporal pattern. Note that the system in FIG. 2A is flexible in the sense that the AV indexer can be implemented on a remotely-connected computer. However, the system involves some latency in indexing the current broadcast AV program in real-time, as due to the delays caused by video encoding, buffering by a file system in the storage 208 and video decoding.

An alternate indexing system shown in FIG. 2B is similar to the system in FIG. 2A except that the digitized analog signal 214 or digital signal 218 uncompressed frames are also delivered directly to the AV indexer 210, and are preferably used to show the current broadcast program to an indexing operator, to construct a visual spatio-temporal pattern, to detect shot boundaries/scene cuts, and to generate key frames without any delay. The clock 220 may be used to synchronize the digitized analog stream 214 or the digital stream 218 directly input to AV indexer with the stored stream 208 encoded by AV encoder 206. As a result, the metadata for the current broadcast AV program can be generated in real-time. The AV indexer 210 also preferably uses the AV file in the storage 208 in order to access the part of the AV program that has been already broadcast, allowing an indexing operator to verify and refine the real-time indexing result/metadata.

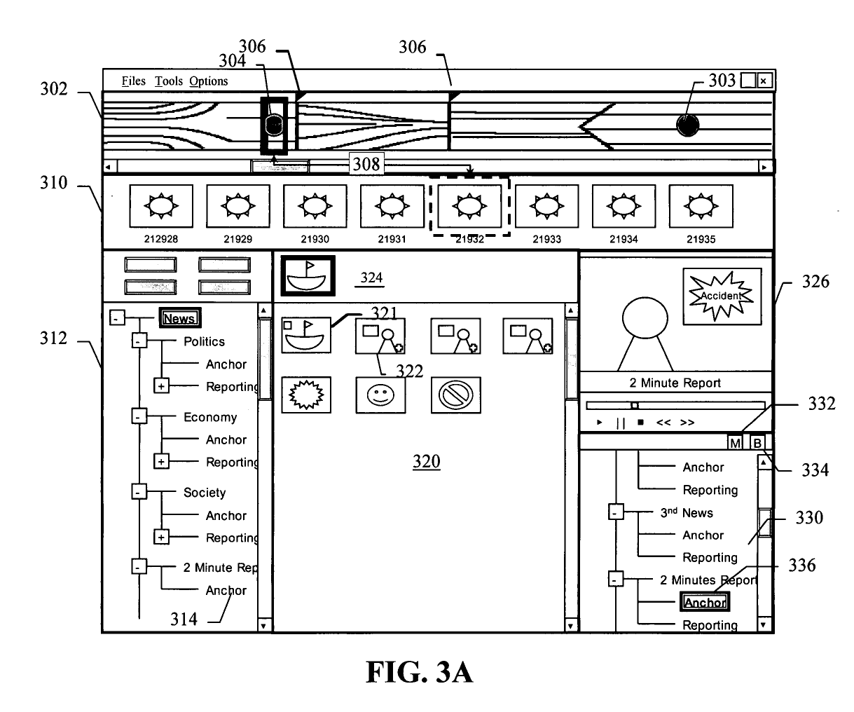

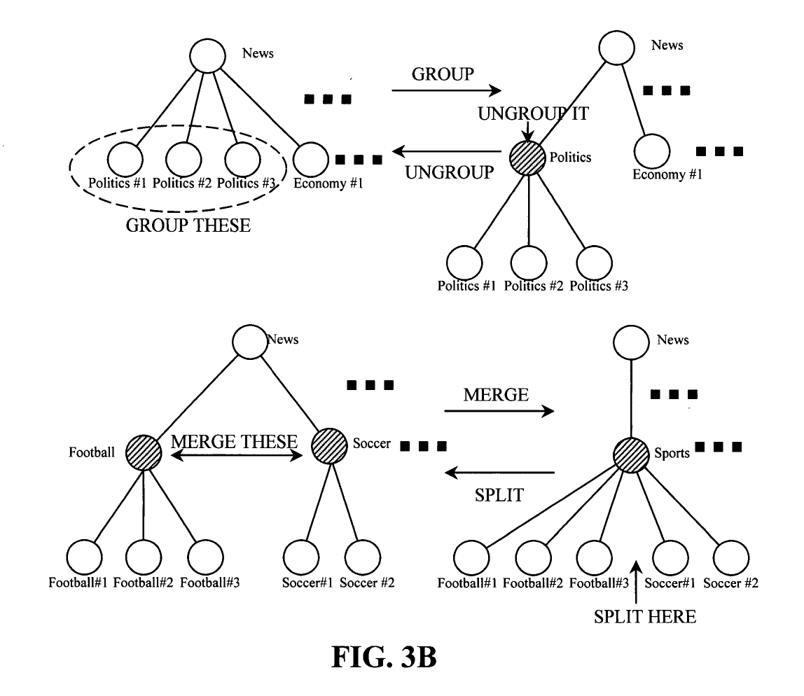

FIG. 3A shows a screen shot of an exemplary graphical user interface (GUI) for a real-time AV indexer, such as 210 in FIGS. 2A and 2B. The GUI comprises the following interacting windows for: a visual spatio-temporal pattern 302, a list of consecutive frames 310 (shown as consecutively numbered frame 21928, 21929, . . . , 21937), a segment hierarchy 312 in textual description, a list of key frames at a same level of the segment tree hierarchy 320, an information panel 324, a AV/media player 326, a template of a segment hierarchy 330, a segment-mark button 332, and a bookmark button 334 (Note: Effective exemplary video bookmarks are disclosed U.S. patent application Ser. No. 09/911,293 filed Jul. 23, 2001 (published as US2002/0069218A1 on Jun. 6, 2002). While a live program is being broadcast, or otherwise being reviewed by the GUI, the AV indexer generates a visual spatio-temporal pattern 302, detects shot boundaries, and generates a key frame whenever a new shot/scene is detected in real-time. The AV indexer shows an indexing operator the current broadcast program on the AV player 326, and then the operator selectively clicks on the segment-mark button 332 whenever a new meaningful segment for the program occurs or starts.

The visual spatio-temporal pattern 302 of a video, which conveys information about the visual content of the video, is preferably a single image, that is, a two-dimensional abstraction of the entire three-dimensional content of the video constructed by sampling a certain group of pixels of each frame and temporally accumulating the samples along time axis. It is useful, inter alia, for both automatic shot detection and visual verification of the detected shots. The triangle(s) 306 area on the top of the visual spatio-temporal pattern indicates the location where a shot boundary is automatically found using a suitable method. When a vertical line corresponding to a frame 308 (shown in FIG. 3A as frame 21932) is selected on the spatio-temporal pattern 302, a list of the consecutive frames 310 centered at the selected frame 308 is displayed, allowing the operator to easily verify the frame discontinuity (or shot boundary) simply by looking over the sequence of consecutive frames, whereby an operator can create a new shot boundary if missed, or delete a shot boundary if falsely detected. The circular mark 303 represents a position on the visual spatio-temporal pattern, as marked by an indexing operator using the segment-mark button 332, when a new meaningful segment starts or occurs while watching an AV program through the player 326. The circular mark 304 shows a position on the visual spatio-temporal pattern 302, bookmarked as by an indexing operator using the bookmark button 334 in order to revisit it later. Segment-marks and bookmarks on a spatio-temporal pattern 302 visually indicate the positions of an AV program currently being indexed, preferably that an indexing operator wants to later revisit in order to verify and refine shot boundaries and segment hierarchy.

The template of a segment hierarchy 330 illustrates a pre-defined representative hierarchy of segments for AV programs. For example, a news segment is typically composed of an anchor shot/scene in which an anchor introduces a summary and the following scenes reporting detailed news, and thus a template of segment hierarchy for a news program can be easily generated by the repeating pattern of “anchor” and “reporting.” A program can be efficiently indexed by using a template as long as the program to be indexed has the segment hierarchy that is the same as, or similar to, the template. For the news example, when a new “Anchor” scene, corresponding to the “Anchor” segment 336 in the template, starts after the “2 Minutes Report” while watching the broadcast news through 326, the operator may click on the segment-mark button 332. Upon clicking the segment-mark button 332, the segment-mark 303 appears on the spatio-temporal pattern 302, and a new segment 314 having the same title and position as the “Anchor” segment 336 in the template hierarchy is created in the segment hierarchy 312.

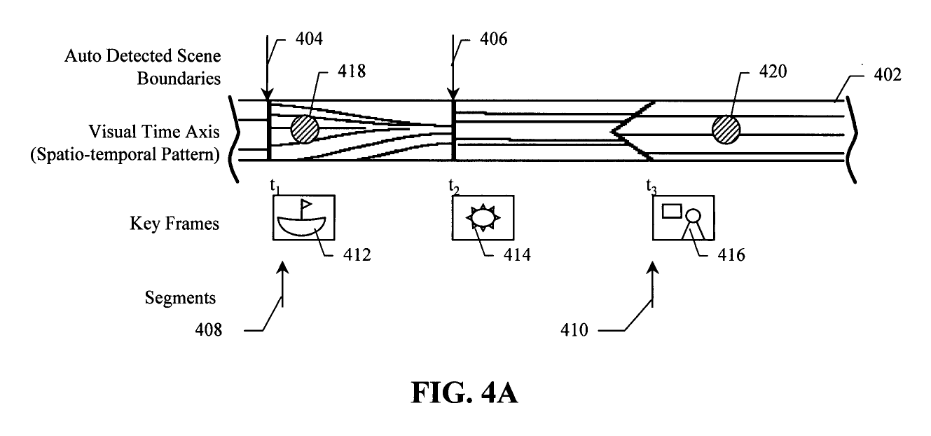

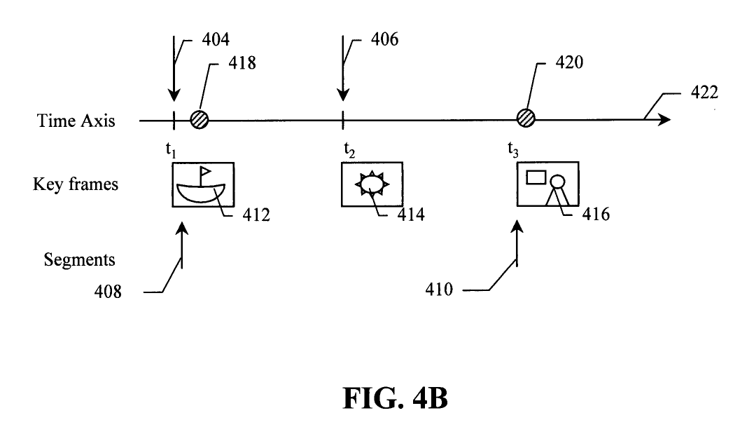

An AV program can be easily indexed by using the segment-mark button 332 and the bookmark button 334. By simply clicking the segment-mark button at the time instant that an indexing operator observes the start of a new meaningful segment (for example, the start of an anchor scene/shot reporting a new topic during a news program) while watching an AV program via the AV player 326, the operator can visually mark the corresponding time position on the spatio-temporal pattern 302 (for example, the circular mark 303), and generate a new segment (for example, at 314) in the segment hierarchy 312. The start time, represented as by media time or broadcasting time or equivalent, of the new segment is automatically set to the start time of the shot whose time interval contains the time instant of clicking the segment-mark button 332. However, the start time of the shot should be corrected by the operator if the correct shot boundary was not automatically detected as described later in FIG. 4A. The duration of the segment immediately before the new segment is determined as time difference between the start time of the previous segment and the start time of the current segment. When a template of a segment hierarchy is available during indexing, a new segment (for example, the Anchor segment 314) is automatically generated at the position of the segment hierarchy corresponding to the position of the template segment hierarchy (for example, the Anchor segment 336 in the template), and the default title of the new segment is obtained from the corresponding segment in the template. When the template is not available, the untitled new segment is created in the segment hierarchy and the operator types in an appropriate segment title. The segment-mark 303 on the spatio-temporal pattern 302 window allows an operator to easily verify and refine the segment hierarchy later, for example, to examine a possible boundary of the first shot of a particular segment which is missed by a shot boundary detector.

The bookmark button 334 may be used for marking time points of interests on the spatio-temporal pattern 302 window (for example, at 304) so that an operator can revisit them later, for example, to replay the bookmarked positions for some reason(s). When indexing a broadcast program in real-time, the operator has to concentrate on the indexing of the current broadcast stream and thus the operator cannot spend much time in indexing a particular part of the broadcast program. In order to solve this problem, it is herein disclosed to use the bookmark button 334, allowing the operator to quickly access the bookmarked positions of the broadcast program later. In other words, the bookmark button 334 may be used when the operator observes some important, interesting, or suspicious positions to revisit later.

The segment hierarchy 312 shows a tree view of segments for an AV program currently being indexed. An exemplary way of expanding and collapsing tree nodes is similar to the well-known Windows Explorer on Microsoft Windows. When a node in the segment tree 312 is selected by the operator as the current segment, a key frame of the current segment is displayed together with the property such as start time and duration in the information panel 324, and a list of key frames of all sub-segments of the current segment 320 is displayed. A segment is usually composed of a set of consecutive shots wherein a shot consists of a set of consecutive frames having, either visually or semantically, similar scene characteristics. A key frame for a segment is obtained by selecting one of the frames in a segment, for example, the first frame of the segment. When a leaf node in the segment tree 312 is selected by an operator as the current segment, a list of key frames of all shots contained in the current segment 320 is displayed. The shot boundaries are preferably automatically detected by using a suitable method and the key frame for each shot is obtained by selecting one of frames in a shot. As a new shot is detected, its key frame is registered into the appropriate position of the segment hierarchy. Various visual identifiers, such as icons may be used, some exemplars are described. A rectangle 321 on a key frame indicates that the key frame represents the whole video. In other words, the key frame with the rectangle corresponds to the root node in the segment hierarchy. A cross 322 on a key frame indicates that the segment corresponding to the key frame has child segments. In other words, a segment consists of one or more child segments.

The segment hierarchy shown in the tree view 312 is provided with usually four operations to manipulate the hierarchy, such as group, ungroup, merge, and split as shown in FIG. 3B. The group operation is used to generate a new node into which semantically related segments are grouped. In a news program, for example, there could be several reports within a same category such as “Politics,” “Economy,” “Society,” “Sports,” and so on. In this case, the reports related with politics are grouped together under a new node “Politics” by the group operation. The ungroup operation is the inverse operation of group. The merge operation is similar to the group operation except that it does not generate a new node. Thus, when reports were grouped into a smaller category such as “Football,” “Soccer,” “Baseball,” and so on, and the indexing operator wants to group the reports into a larger category without changing the number of levels, the merge operation makes reports merged into a single category “Sports.” The split operation is the inverse operation of the merge operation.

The AV player window 326 is used to display the AV program being broadcast, or otherwise provided, (for example, available at 216 or 218 in FIG. 2B) and to play back selected segments of part(s) of the AV program already stored in the storage 208. It also preferably has associated with it VCR-like controls such as play, stop, pause, fast forward, fast backward, and, so on.

The technique of visually marking a position of interest on a spatio-temporal pattern, such as 302 in FIG. 3A, as disclosed herein is of great help to an operator while indexing a broadcast program in real-time. FIGS. 4A and 4B illustrate the advantage of marking on a visual time axis 402 showing a spatio-temporal pattern over marking on a time axis 422 showing a simple time scale. FIGS. 4A and 4B show two shot boundaries 404 and 406 that are detected, preferably automatically, by a suitable method and their key frames 412 and 414 at their corresponding time points t₁ and t₂ on the visual time axis 402 in FIG. 4A (corresponding to the spatio-temporal pattern 302 in FIG. 3A) and on the time axis 422 in FIG. 4B, respectively. Note that the shot boundary at time t₃ is not usually automatically detected due to, for example, gradual scene transition since it is still difficult to perfectly detect all shot boundaries without error, especially those caused by the gradual transitions such as “dissolve,” “wipe,” “fade-in,” and “fade-out” by using the current state-of-the-art methods of shot boundary detection. Thus, it is often necessary for human operators to manually verify and correct the result(s) of automatic shot boundary detection, and it is advantageous if there is a way of quickly skimming through a video for verification and correction. Suppose that two new segments with key frames 412 and 416 of the program start at t₁ 408 and t₃ 410, respectively. First, consider the case when the visual time axis 402 is used shown in FIG. 4A. The operator, who is viewing the program, as through the AV player 326 in FIG. 3A, clicks the segment-mark button 332 when a new segments starts at t₁ 408, and then the segment-mark 418 appears on the visual time axis 402. A new segment with the start time t₁ and the key frame 412 at t₁ is then automatically appended to the segment hierarchy, such as 312, wherein the operator does not have to correct the start time t₁ of the new segment since the operator can clearly see the automatically detected shot boundary 404 at t₁ just before the segment-mark 418 on the visual time axis 402. When another new segment starts at t₃ 410, the operator again clicks the segment-mark button 332, and the segment-mark 420 appears on the visual time axis 402, resulting in a new segment with the start time t₂ and the key frame 414 at t₂ is then automatically appended to the segment hierarchy, such as 312. However, in this case, it is clear to the operator that the start time of the new segment is not correct since the operator cannot see the automatically detected shot boundary just before the segment-mark 420 on the visual time axis 402. Thus, the operator can guess the existence of a new segment boundary around the segment-mark 420, make a decision where to make a new segment boundary by just a quick glance at the visual time axis or spatio-temporal pattern 402 around the segment-mark 420, and update the start time of the new segment to t₃ 410 and its key frame to the frame 416 in the segment hierarchy. That is, without playing the suspicious portion around the segment-mark 420, the operator can identify the missing shot boundary that the shot change detector failed to automatically find, for example, due to the gradual transition. For example, the indexing operation can identify without playing the marked portion around the segment-mark 420 that the portion is edited with a “wipe” editing effect, thus a new segment boundary might occur. This will greatly reduce the time necessary for the operator to manually search the suspicious portions and decide where there are segment boundaries. Further, the operator can easily access the frames near the time point indicated by the segment-mark 420 (for example, see the list of consecutive frames 310 in FIG. 3A), and verify the guess on shot boundary whenever the operator has time to probe the portion near the segment-mark or after the program being indexed is finished. On the other hand, if a time axis 422 in FIG. 4B showing a simple time scale is used instead of the visual time line 402, it is difficult to quickly locate the segment boundary near the segment-mark 420. In other words, with the interface of the AV indexer such as FIG. 4B, the indexing operator can not quickly decide where a new segment boundary around the segment-mark 420 is, and thus has to play back the marked portion, which makes it difficult to index the broadcast program in real-time.

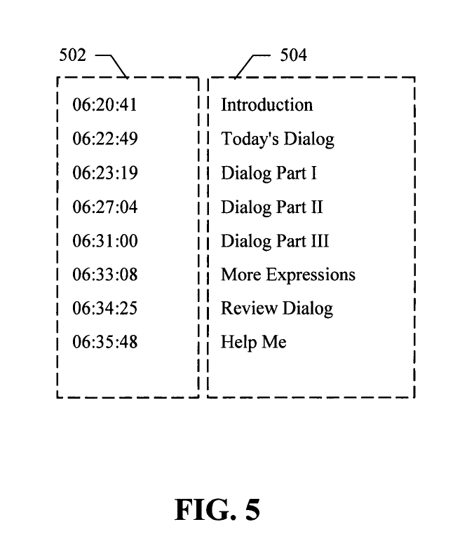

FIG. 5 shows an exemplary 1-level metadata on the segment hierarchy for an educational program using a broadcasting time. Since the program is broadcast with almost the same structure 504 everyday, an operator can pre-generate a template of a segment hierarchy for the program. Before indexing the program, the operator loads the pre-defined template into the AV indexer 210 in FIGS. 2A and 2B. Then, whenever the operator observes a new segment (for example, “Today's Dialog” in FIG. 5) that is indicated by the template while watching the broadcast program, the operator can easily generate a new segment with a start time in broadcasting time 502 into the segment hierarchy 312 in FIG. 3A by just clicking on the segment-mark button 332. If the operator misses a segment or finds a suspicious portion to revisit later during indexing, the operator marks the position on the visual time axis 302 by just clicking on the bookmark button 334. The operator can later examine the positions of the program marked by the segment-mark button 332 and bookmark button 334 by directly accessing to the corresponding time points, and update/edit the segment hierarchy having been built if needed. Therefore, by using the disclosed technique, the indexing operator can verify the segment hierarchy, generate accurate segmentation metadata, and then transmits it to broadcaster at appropriate times within a minimum time delay.

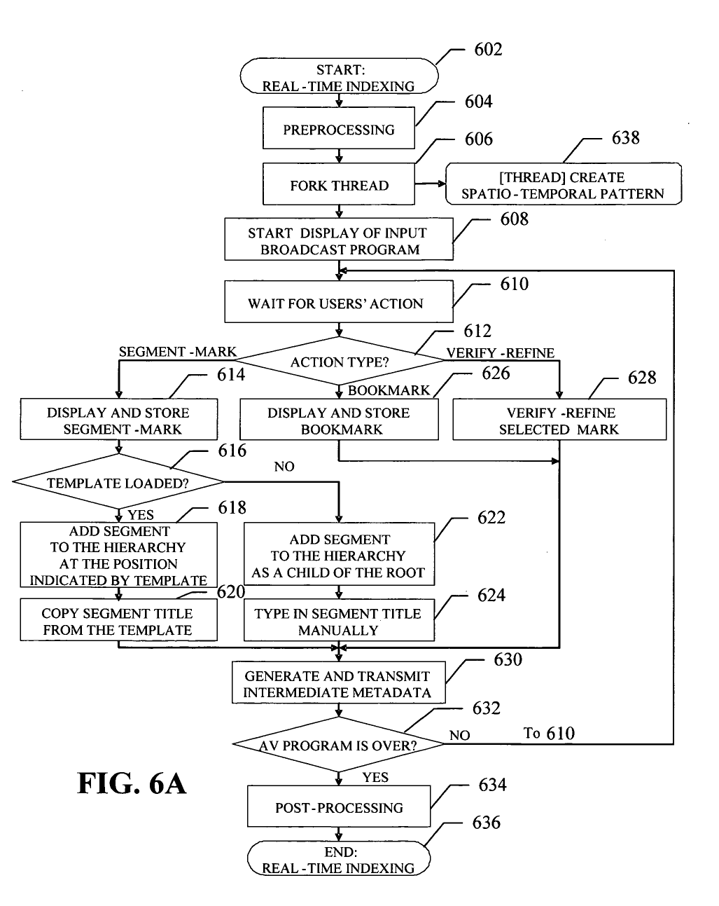

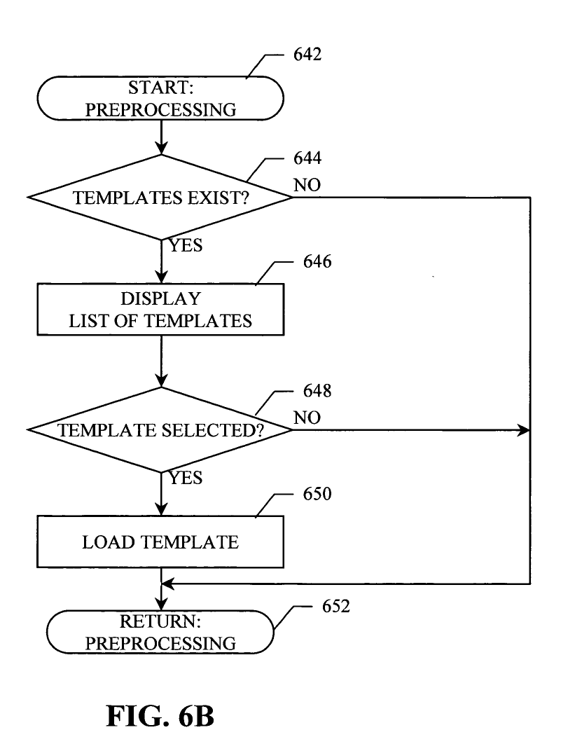

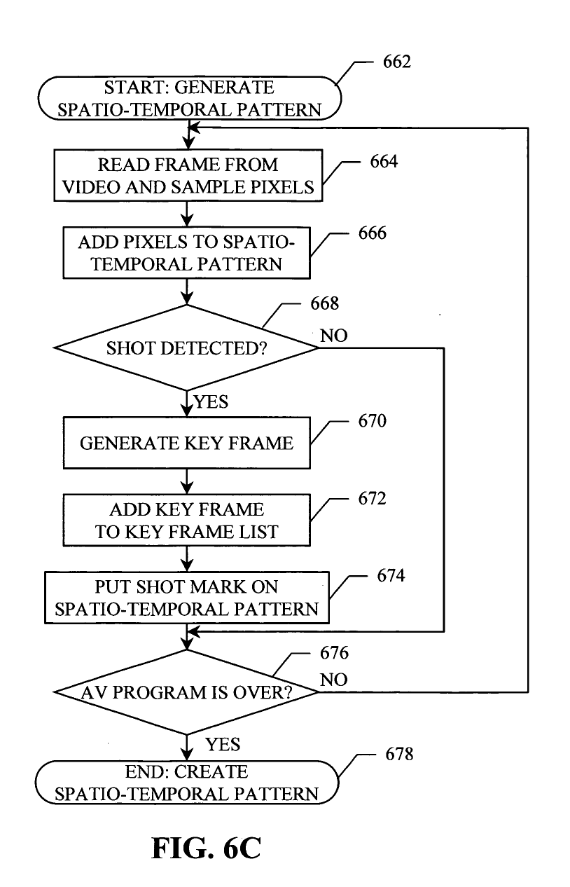

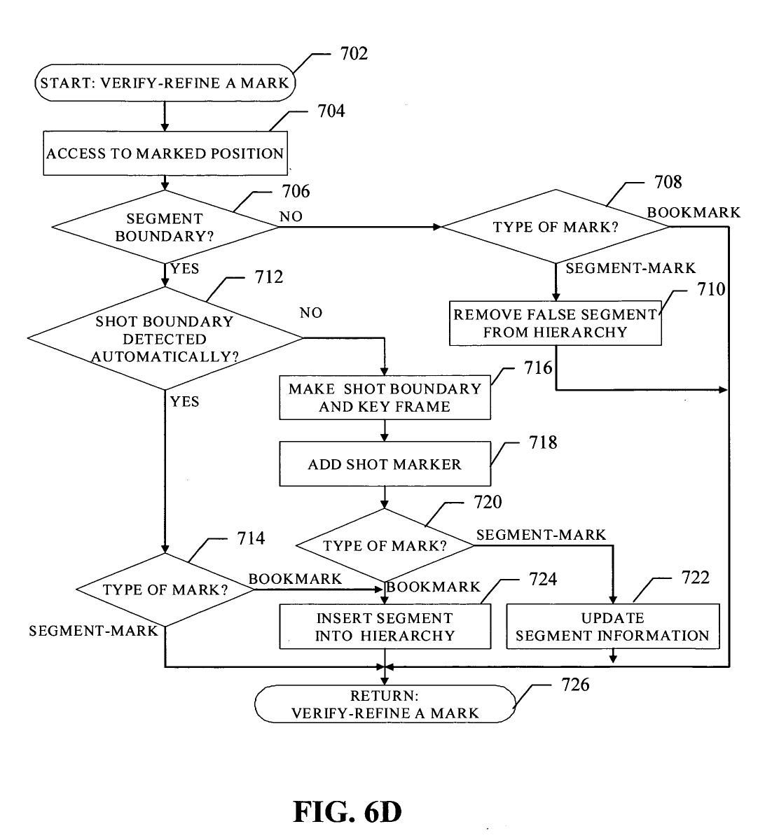

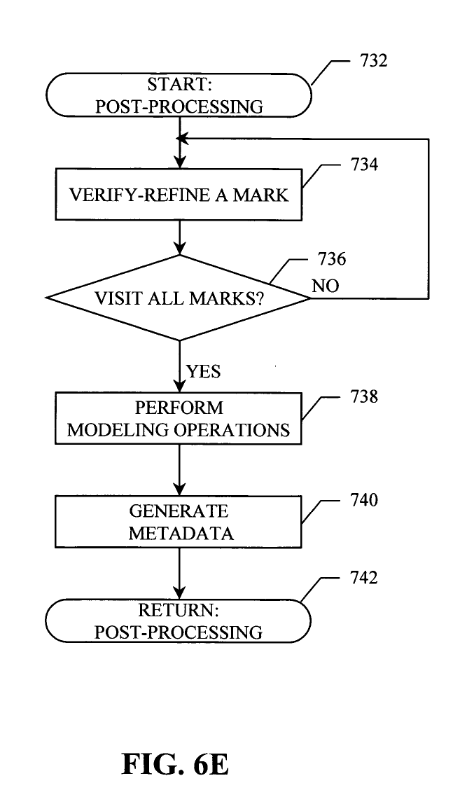

FIG. 6A shows the flow chart of the disclosed real-time indexing system for a digital/digitized AV program. The real-time indexing process begins at Step 602 followed by Step 604 where a preprocessing for loading an appropriate template, if available, is performed as described in FIG. 6B. A thread for the creation of a spatio-temporal pattern 638 whose process is shown in FIG. 6C is forked at Step 606, and an input digital/digitized live broadcast program starts to be displayed in the player window 326 in FIG. 3A at Step 608. The system waits for an operator's action such as “segment-mark,” “bookmark,” and “verify-refine” at Step 610. An operator is monitoring the broadcast program through the AV player 326 while waiting for a new meaningful segment to occur or start. First, when a new segment occurs, the operator clicks on the segment-mark button 332 in FIG. 3A and the action type is decided as “segment-mark” at Step 612. Then, a new segment-mark 303 appears on the spatio-temporal pattern window 302 in FIG. 3A, and a start time set by that of the leading shot of the marked segment and the relevant information are stored in the local storage at Step 614. The system proceeds to Step 616 to check if a template 330 is available for the program. If “YES,” the new segment is added to the hierarchy at the position indicated by the template and the segment title is copied from the template at Steps 618 and 620, respectively. Otherwise, the new segment appended to the hierarchy as a child of the root, and the operator manually types in the segment title at Steps 622 and 624, respectively. Second, if the operator finds a position of interest though it is not considered as a segment boundary, the operator clicks on the bookmark button 334 in FIG. 3A and the action type is decided as “bookmark” at Step 612. Then, a new bookmark 304 is displayed on the spatio-temporal pattern 302, and its temporal position and other relevant information are stored in the local storage at Step 626. Third, whenever the operator has time, the operator can visit one of the stored marked positions wherein the action type is decided as “verify-refine” at Step 612. Then, the operator can verify and refine the mark at Step 628 that is described in more details in FIG. 6D. After each action is performed, the system generates an intermediate metadata specified in TV-Anytime or others, stores it in the local storage 212 in FIGS. 2A and 2B, and transmits it to the broadcaster as shown in FIGS. 1A, 1B and 1C at Step 630. The system proceeds to Step 632 to decide whether the AV program is finished. If so, the system performs the post-processing shown in FIG. 6E at Step 634 and ends at Step 636. If not, the process goes back to Step 610.

FIG. 6B shows the flow chart of the preprocessing process for loading a template. The process starts at Step 642 and checks if any available template exists at Step 644. If exists, the process displays a list of all available templates at Step 646 and otherwise returns to the parent process. The process checks if a template is selected at Step 648. If a template is selected, the process loads the template and displays it in the window 330 in FIG. 3A at Step 650. Otherwise, the process goes to Step 652 to return to the parent process.

FIG. 6C shows the flow chart of the process of generating the spatio-temporal pattern. The thread begins at Step 662, reads a frame from the digital/digitized input live broadcast stream, samples a set of pixels from the frame at Step 664, converts them to a vertical array, and appends the vertical array or line to the spatio-temporal pattern at Step 666. Note that appending and displaying the vertical line corresponding to a frame to the spatio-temporal pattern is synchronized with displaying the frame at Step 608 in FIG. 6A through the AV player 326 in FIG. 3A. The thread checks at Step 668 whether there is a shot boundary detected using a suitable method near the appended line that corresponds to the frame read at Step 664. If “NO,” the thread goes to Step 676. If “YES,” the thread generates a key frame of the new shot at Step 670, stores it in a key frame list at Step 672, and put a shot mark 306 on the spatio-temporal pattern 302 in FIG. 3A at Step 674. The thread proceeds to Step 676 to determine whether the AV program is finished. If “YES,” the thread ends at Step 678, and otherwise loops back to Step 674 to continue to generate the spatio-temporal pattern.

FIG. 6D shows the flow chart of an exemplary process, that is used for the block 628 in FIG. 6A and the block 734 in FIG. 6E, of verifying and refining either a given segment-mark or a given bookmark. The process begins at Step 702. The operator visits or accesses a marked position whether it is a segment-mark or a bookmark, and the part of the spatio-temporal pattern around the marked position is displayed in the window 302 in FIG. 3A at Step 704. The operator checks or verifies whether there is a segment boundary near the marked position at Step 706. A segment boundary, if exists, will usually occur at the temporal position immediately before the mark on the visual time axis due to the inevitable but short delay caused by human's sensory response. If “NO,” the process goes to Step 708 to see the type of the given mark. If the given mark is a segment-mark, the segment that was falsely determined as a new segment is removed from the hierarchy, and the segment-mark is deleted or changed to a bookmark for possible later use at Step 710. If the given mark is a bookmark at Step 708, the process returns to the parent procedure. If the operator confirms that there is a segment boundary near the marked position, the operator checks at Step 712 if the boundary of the leading shot of a new segment near the given mark was correctly detected by a suitable method. If the shot boundary was automatically detected, the process checks if the mark is a segment-mark or a bookmark at Step 714. If the mark is a segment-mark, the process goes to Step 726 to return to the parent procedure. If the given mark is a bookmark at Step 714, the segment whose boundary is set to the shot boundary checked by the operator at Step 712 is inserted at an appropriate position into the segment hierarchy 312 in FIG. 3A, for example as a sibling of the previous segment, at Step 724. If the operator decides that the shot boundary was not automatically detected at Step 712, the operator creates a shot boundary manually and generates its key frame and relevant information at Step 716. A shot marker such as the blue triangle 306 in FIG. 3A is then added to the spatio-temporal pattern 302 at Step 718. The process checks the type of the given mark at Step 720. If the given mark is a segment-mark, the process updates information of the segment including its start time and key frame as well as information of other relevant segments. If the given mark is a bookmark, the process inserts a new segment having the start time and key frame as those obtained at Step 716 at an appropriate position into the segment hierarchy 312, and changes the bookmark into a segment-mark at Step 724. At Step 726, the process returns to the parent procedure. Note that the operator can perform the modeling operations on the segment hierarchy such as group, ungroup, merge, and split before returning to the parent procedure.

FIG. 6E shows the flow chart of the post-processing. The process starts at Step 732. After all marks are visited, verified and refined at Steps 734 and 6736, the operator builds or edit a segment hierarchy by performing the modeling operations such as group, ungroup, merge, and split at Step 738. The process generates a complete version of segmentation metadata of the input AV program at Step 740. The process of the post-processing returns at Step 762.

The disclosed system and method for real-time indexing can be applied to an AV program whether the AV program is being live broadcast or is a recorded/stored file.

Billing of Metadata

An object of the techniques of the present disclosure is to provide a method of charging for a metadata used by users. Typical approaches for charging for the use of metadata would be by charging a metadata user through monthly bill by service provider. However, the type of metadata used could be a confidential matter between TV viewers in a family especially if it is related to adult movies or games and thus could restrict the usage of metadata that is not free. Therefore, a new scheme is provided to avoid such issue on privacy by charging the use of metadata through cellular phone network company since most people own their own cellular phones and their own bill information can be opened in privacy.

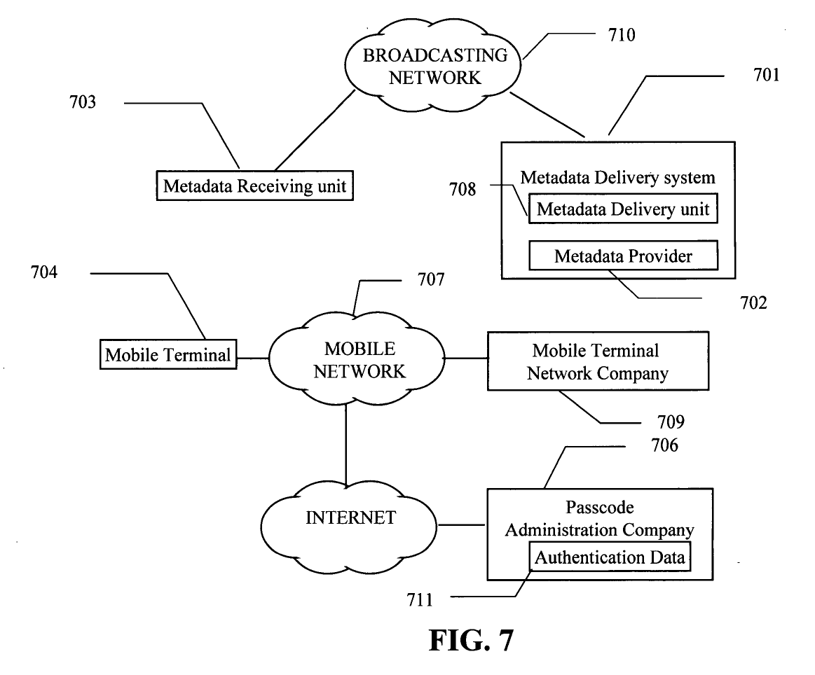

FIG. 7 is a schematic view of showing a metadata delivery system according to an embodiment of the present disclosure. In order to accomplish the object, a first aspect of the present disclosure provides a metadata delivery system 701 including a metadata delivery unit 708 for delivering metadata, a metadata receiving unit 703 for receiving the metadata from the metadata delivery unit 708, a mobile terminal 704 connected to the network through mobile communication network 707, a passcode administration company 706 for preparing passcode data, and a mobile terminal network company 709 which manages the mobile communication network 707 and its service. The metadata delivering system 701 includes the metadata delivery unit 708 responsible of delivering the metadata provided by the metadata provider 702 through broadcasting network (e.g. satellite or cable) 710, a DVR 703 serving as the metadata receiving unit belonging to a user, a cellular phone network or a mobile communication network 707 managed by mobile terminal network company 709, a cellular phone or a mobile communication terminal 704 belonging to the user, and a passcode administration company 706.

With the above-mentioned arrangement, the passcode administration company 706 conducts registration with a managing company 709 of the cellular phone network 707 so that the cellular phone network management company may bill the user for charges of metadata used by the user.

To receive the metadata for use in the DVR, the user employs a cellular phone 704 to access to the passcode administration company of the respective metadata. After making a contract for using the metadata, the passcode administration company prepares a personal passcode data 711 and displays the data in the display device of a mobile terminal 704. The management company of the cellular phone network 709 bills the user who receives the passcode data through the passcode administration company. The passcode administration company 706 obtains a communication carrier from the management company of the cellular phone network 709, and accumulates charges by deducting a commission of several percents from the amount to the user billed by the management company of cellular phone network. The commission of passcode administration company 706 thus covers the cost for preparing a personal passcode data 711. Upon the successful reception of passcode data, the user inputs the passcode data through the remote control of the metadata receiving unit 703. For example, the passcode data may be a 4-digit number that is displayed on the display device of a mobile terminal 704 and is input through the remote control of a DVR. If the personal passcode is successful, the metadata information is then used to guide DVR users to segments of interest.

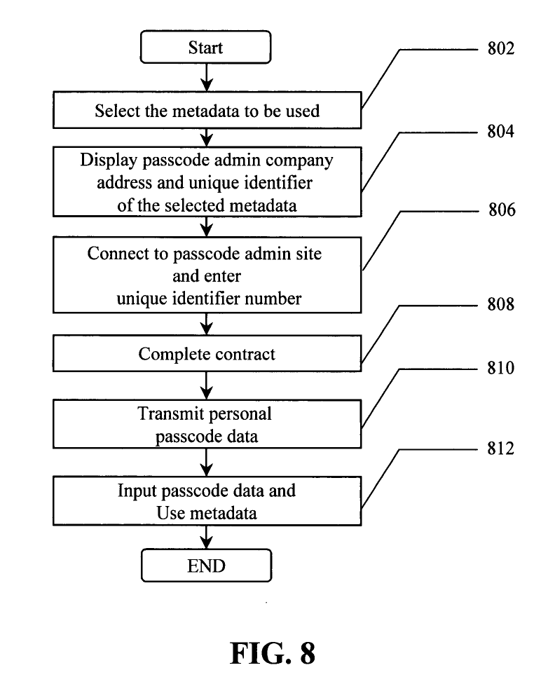

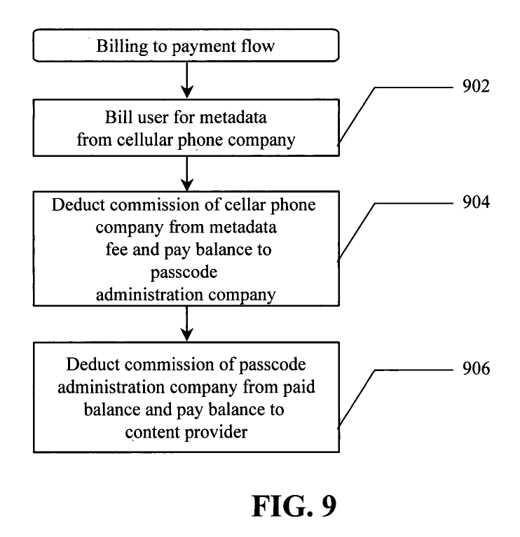

FIGS. 8 and 9 are flow charts showing the processes according to the present disclosure, in which FIG. 8 shows the content acquisition process and FIG. 9 a billing-to-payment process. In step 802 of FIG. 8, the user first selects a metadata to be used from the DVR. Namely in response, the DVR displays a site address of passcode administration company and a unique identifier for identifying the metadata to be used as in step 804. Then, the user accesses the passcode administration company site through the mobile terminal, and enters the unique identifier as in step 806. After the unique identifier is input, the passcode administration company prepares the personal passcode data. Step 808 completes a contract. After a contract is made, the prepared personal passcode data is transmitted to the mobile terminal and displayed at the terminal in step 810. In step 812, the user inputs the displayed passcode data to the DVR and the metadata is used to guide DVR users to segments of interest.

FIG. 9 shows the billing-to-payment process. In step 902 of FIG. 9, the management company of cellular phone network bills the user for the metadata. Step 904 deducts the commission of several percents of the cellular phone network management company from the metadata charge paid by the user to the cellular phone network management company and pays the balance to the passcode administration company for preparing for the passcode data. In step 906, the passcode administration company deducts the commission of several percents from the paid balance and pays the balance to the metadata provider. As a result, the management company of the cellular phone network receives the commission for the usage of the passcode administration company, and the passcode administration company receives the commission for personal passcode data. The metadata provider then receives the balance as charges for delivered metadata.

Audio Metadata Service for a Mobile Device

As mobile devices such as mobile phone and Personal Digital Assistant (PDA) increasingly become equipped with a broadcast receiver, a large memory and a high-speed processor to receive, store and play music files such as MP3 collections, Digital Radio Recorder (DRR) software will be added as an additional application.

Mobile devices with DRR functionality allow users to record broadcast audio into their memory and play the recorded audio at any time they want. The users will be able to find, navigate, and manage the recorded audios in their mobile devices using textual metadata delivered by radio broadcasters or third-party metadata service providers through the communication network built-in the mobile device. Especially, segmentation information of the metadata that locates temporal positions or intervals within a broadcast audio allows users to browse it according as the metadata providing hierarchical or highlight browsing. Thus, it is also needed to associate the delivered metadata with the segments of the audio recorded in their mobile devices.

For the media localization of a metadata for the corresponding media (an audio program), a broadcasting time representing current time of a program being broadcast is utilized even in analog audio broadcast. For example, the broadcasting time might be acquired from the GPS time carried on the sync channel defined in IS-95A/B/C Code Division Multiple Access (CDMA) standard. Moreover, if a device supports Internet connection, the broadcasting time might be acquired from a time server connected in Internet, which provides coordinated universal time (UTC).

Therefore, by using the broadcasting time, analog audio broadcast programs can be indexed and their segment information can be browsed according to the metadata especially for mobile devices having DRR functionality.

Furthermore, since the mobile device moves to anywhere and the frequency of a radio broadcaster might vary according to the broadcasting regions, the program guide information has to carry frequencies of the related regions and a mobile device can tune the appropriate frequency of the broadcaster at any regions. For this purpose, it is also required to provide program guide information specially designed for mobile devices.

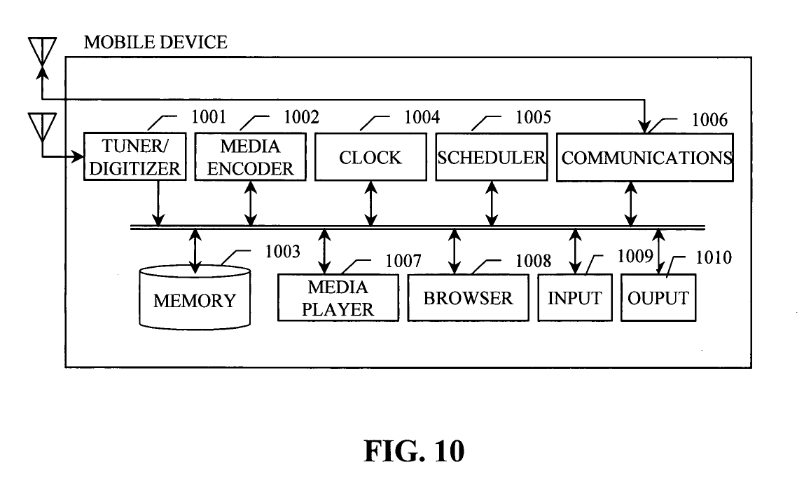

FIG. 10 shows an exemplary block diagram of a mobile device that has an analog tuner and the DRR functionality.

The module of tuner/digitizer 1001 receives broadcast audio signal and converts it to the digitized broadcast signal.

The media encoder 1002 encodes the digitized broadcast signal and stores it into the memory 1003 when it is the reserved time of a broadcast program to be recorded.

The clock 1004 is synchronized with UTC (formerly known as Greenwich Mean Time (GMT)) received through communications 1006. For example, in case of mobile phone the local clock is synchronized with the system time carried on the sync channel defined in IS-95A/B/C CDMA standard. Further, in case of a device supporting Internet connection, the local clock of the device might be synchronized with UTC provided by a time server through network time protocol.

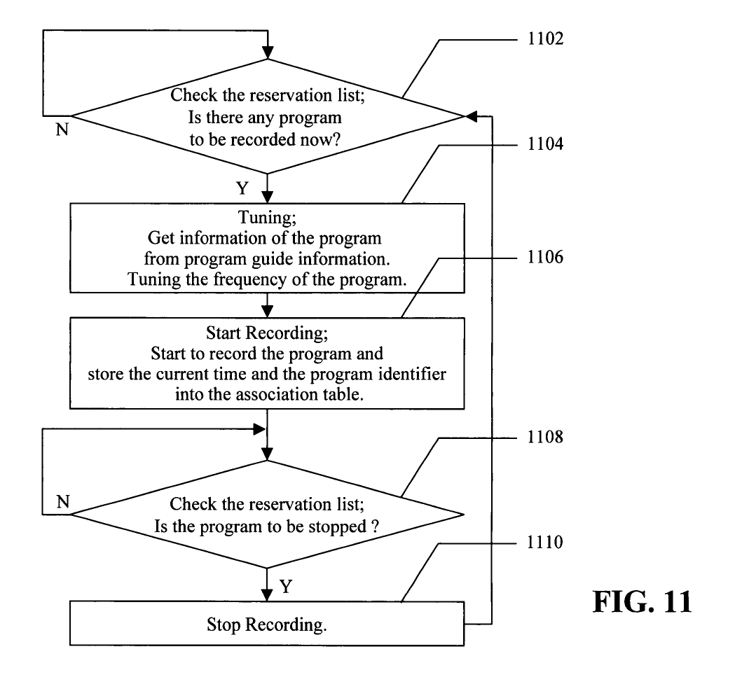

The scheduler 1005 provides users a graphic user interface such that he/she can select a program and reserve the program to be recorded later. The scheduler 1005 checks the reservation list so as to know which program is to be recorded and to be stopped. The details of the procedure will be described later with FIG. 11.

The communications 1006 is used for mobile device communications such as, in case of mobile phone, call setup signals, mobile device system time signals and digitized voice signals, etc. Further, the metadata might be delivered through the communications interconnecting the service provider's hosts such as Nate and magicn service hosts in Korea. In case of PDA, Internet protocols might be supported through the communications 1006.

The media player 1007 decodes a recorded program stored in memory 1003. After decoding the recorded program, the media player 1007 sends the decoded signal to the output device 1010.

The browser 1008 displays the segment information of the recorded program according to the metadata that is received from the metadata providers through the communications 1006. The browser may play segments and replay.

The input 1009 and output 1010 modules are responsible for user's input such as buttons and user's output such as speaker and display respectively.

FIG. 11 shows the flow of recording procedure of the scheduler 1005. Herein, the metadata as well as program guide information might be delivered to the mobile device by using push-service or pull-service through the communications 1006 interconnecting service provider's hosts. In step 1102 of FIG. 11, the scheduler 1005 checks the reservation list such as comparing current time with the reserved recording start time of a program listed in the reservation list, to determine which program is to be recorded. If a program is determined to be recorded, the scheduler 1005 extracts the frequency information (channel information) of the program from the program guide information received via communications, and the tuner/digitizer 1001 tunes to the frequency in step 1104. In Step 1106, the media encoder 1002 starts to encode and store the broadcast audio into the memory 1003, and the scheduler stores the current time with the program identifier, such as file name or file identifier, into the association table. The exemplary association table is shown in Table 1. Later, using the association table the browser 1008 can display the segment information of the recorded audio program according to the broadcasting time. While the program is recording, the scheduler 1005 checks the program ending time and determines whether the recording procedure is to be stopped in step 1108. If the program is over, the scheduler stops recording in step 1110 and the procedure goes back to the step 1102 to check the reservation list.

TABLE 1
The exemplary Association Table

| Program Identifier | Start time | Ending Time |
|---|---|---|
| Program_ID_1 | 2003.07.10 06:00:00 | 2003.07.10 06:20:00 |
| . | . | . |
| . | . | . |
| . | . | . |

Moreover, it is important to store the system time with the encoded stream when the mobile device encodes and records the audio program. One of the possible ways is to encode the audio signal in the form of MPEG-2 transport stream including system information such as MPEG-2 private section for current time, for example STT defined in ATSC-PSIP. Another way is to use a byte-offset table that contains a set of temporally sampled reference times such as broadcasting times or media times and its corresponding byte positions of the file for the recorded stream as described in U.S. patent application Ser. No. 10/369,333 filed Feb. 19, 2003. Thus, by examining system times contained in recorded streams or using the byte-offset table, the mobile device can access the temporal positions according to the metadata.

Since the mobile device can move to anywhere and the frequency of a radio broadcaster might vary according to the broadcasting regions, the program guide information has to carry the frequencies according to regions so as for the mobile device to tune the appropriate frequency of the broadcaster at any regions.

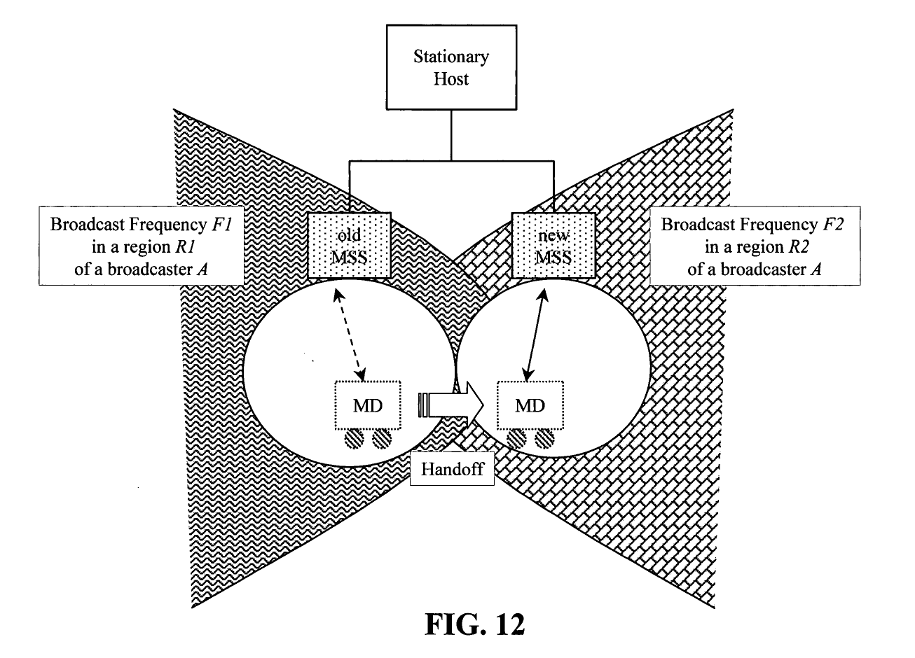

Mobile device can detect its region from the signal of the Mobility Support Station (MSS). As shown in FIG. 12, in case of mobile phone for example, the movement (hand off) of the mobile device can be detected from the mobility support station to which the mobile device is connected. Thus the mobile device can determine whether the mobile device is in a new region and whether the mobile device should receive a new program guide information. For example, when the mobile device receives a broadcast program of a broadcaster and hand offs to new region in which the radio frequency of the broadcaster is deferent from that in previous region, the mobile device might use the program guide information that supplies the radio frequency information of the new region for the same broadcaster.

In addition to the typical information such as channel number, broadcasting time and program title, in case of mobile devices the program guide information has to include the regional information and its local frequency for a program.

Table 2 shows the exemplary program guide information that is composed of two parts. One is the program information and the other is the channel information. The program information has a channel identifier by which an application can access the channel information. The channel information comprises a channel identifier, channel name, media type such as radio FM or AM, a region identifier, and a regional local frequency.

TABLE 2
Program guide information
a) Program Information

| Channel | | | |
|---|---|---|---|
| Identifier | Program Name | Start time | Ending Time |
| CH_ID | Program_ID_1 | 2003.07.10 06:00:00 | 2003.07.10 06:20:00 |
| . | . | . | . |
| . | . | . | . |
| . | . | . | . |

b) Channel Information

| Channel | | | | Regional |
|---|---|---|---|---|
| Identifier | Channel Name | Media Type | Region | Local Frequency |
| CH_ID | KBS 1 | Radio FM | Seoul | 89.1 MHz |
| . | . | . | . | . |
| . | . | . | . | . |
| . | . | . | . | . |

In this way, the method of utilizing broadcasting time for DRR and the program guide information specially designed for mobile device can also be applied to the Digital Audio/Multimedia Broadcasting (DAB/DMB) where the broadcasting time might be carried or obtained from broadcast streams such as MPEG-2 private section for system information, i.e., STT defined in ATSC-PSIP.

It will be apparent to those skilled in the art that various modifications and variations can be made to the techniques described in the present disclosure. Thus, it is intended that the present disclosure covers the modifications and variations of the techniques, provided that they come within the scope of the appended claims and their equivalents.

1. A method of indexing an audio-visual (AV) program comprising:
indexing an AV program with segmentation metadata, wherein a specific position and interval of the AV program are represented by a time-index; and
using at least one technique selected from the group consisting of template, segment-mark and bookmark on a visual spatio-temporal pattern of an AV program during indexing to create a segment hierarchy.

2. The method of claim 1, wherein the segment hierarchy comprises a tree view of segments for the AV program being indexed.

3. The method of claim 1, wherein a template of a segment hierarchy comprises a pre-defined representative hierarchy of segments for AV programs.

4. The method of claim 3, wherein, when a template of a segment hierarchy is available during indexing, a new segment is automatically generated at the position of the segment hierarchy corresponding to the position of the template segment hierarchy.

5. The method of claim 3, wherein, when a template is not available, a new segment is created in the segment hierarchy.

6. The method of claim 1 further comprising utilizing the broadcasting time carried on a broadcast transport stream as a locator allowing direct access to a specific temporal position of a recorded AV program.

7. A graphical user interface (GUI) for a real time indexer for an AV program comprising:
a visual spatio-temporal pattern;
a segment-mark button; and
a bookmark button.

8. The GUI of claim 7, further comprising one or more of:
a list of consecutive frames;
a segment hierarchy in textual description;
a list of key frames at a same level of the segment tree hierarchy;
an information panel;
a AV/media player; and
a template of a segment hierarchy.

9. A method of indexing an AV program comprising:
using a template of a segment hierarchy.

10. The method of claim 9, further comprising:
using a visual spatio-temporal pattern.

11. The method of claim 9, further comprising:
visually marking a position of interest on a spatio-temporal pattern.

12. The method of claim 9, further comprising:
automatically generating a new segment at a position of the segment hierarchy corresponding to a position of the template segment hierarchy.

13. The method of claim 12, further comprising:
obtaining a default title for the new segment from a corresponding segment in the template.

14. The method of claim 9, wherein:
the segment hierarchy shows a tree view of segments for the AV program being indexed.

15. The method of claim 9, wherein:
a segment comprises a set of consecutive shots; and
a shot comprises a set of consecutive frames having similar scene characteristics;
further comprising:
obtaining a key frame for a segment by selecting one of the frames in a segment, for example, the first frame of the segment.

16. The method of claim 9, wherein:
the segment hierarchy is provided with operations to manipulate the hierarchy.

17. The method of claim 9, wherein:
the operations are selected from the group consisting of group, ungroup, merge and split.

18. A method of reusing segmentation metadata for a given AV program delivered at a different times on a same broadcasting channel or on different broadcasting channels, or via different types of delivery networks comprising:
adjusting the time-indices in segmentation metadata for the AV program; and
delivering the segmentation metadata;
wherein a specific position of the AV program in the segmentation metadata is represented by a time-index.

19. The method of claim 18, wherein adjusting the time-indices comprises:
transforming time-indices into broadcasting times.

20. The method of claim 18, wherein adjusting the time-indices comprises:
transforming time-indices into media times relative to a broadcasting time of the start of the AV program.
